(19) United States
(12) Patent Application Publication
(10) Pub. No.: US 2022/0373920 A1
(43) Pub. Date: Nov. 24, 2022

(54) ELECTROSTATIC IMAGE DEVELOPING CARRIER, ELECTROSTATIC IMAGE DEVELOPER, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Takuro WATANABE, Kanagawa (JP); Kazutsuna SASAKI, Kanagawa (JP); Yosuke TSURUMI, Kanagawa (JP); Yasuo KADOKURA, Kanagawa (JP); Karin SAKAI, Kanagawa (JP)

(73) Assignee: FUJIFILM Business Innovation Corp., Tokyo (JP)

(21) Appl. No.: 17/409,157

(22) Filed: Aug. 23, 2021

(30) Foreign Application Priority Data
May 20, 2021 (JP) 2021-085619

(51) Int. Cl. G03G 9/107; G03G 9/113; G03G 21/18; G03G 15/08

(52) U.S. Cl. CPC G03G 9/1075; G03G 9/10884; G03G 9/1139; G03G 9/1133; G03G 21/1814; G03G 15/0865

(57) ABSTRACT

An electrostatic image developing carrier includes core particles provided by dispersing a magnetic powder in a resin and resin cover layers covering the core particles, wherein the resin cover layers have a surface coverage of 96 area % or more, the resin cover layers include 10 mass % or more and 50 mass % or less of inorganic particles relative to a total mass of the resin cover layers, and the inorganic particles in surfaces of the carrier have a surface exposure ratio of 6 atomic % or more and 15 atomic % or less determined by X-ray photoelectron spectroscopy.

### CROSS-REFERENCE TO RELATED APPLICATIONS

This application is based on and claims priority under 35 USC 119 from Japanese Patent Application No. 2021-085619 filed May 20, 2021.

### BACKGROUND

### (i) Technical Field

The present disclosure relates to an electrostatic image developing carrier, an electrostatic image developer, a process cartridge, an image forming apparatus, and an image forming method.

### (ii) Related Art

Japanese Unexamined Patent Application Publication No. 2019-215478 discloses an electrostatic image developer containing toner particles and carrier particles, wherein the toner particles contain, as an external additive, at least silica particles or alumina particles, the carrier particles have core particles and cover resin layers covering the surfaces of the core particles, the cover resin layers contain metal oxide particles, an element of the carrier particles measured by XPS (photoelectron spectroscopy) is at least Si or Al, and at least the Si or Al content relative to all the elements constituting the carrier particles is in the range of 1 to 6 at %.

Japanese Unexamined Patent Application Publication No. 2007-219118 discloses a two-component developer composed of a toner provided by adhering inorganic fine particles to coloring particles and having a volume-based median particle size of 3 to 8 μm, and a carrier provided by adhering inorganic fine particles and having a mass-average particle size of 20 to 40 μm, wherein, for a constituent element (A) of the inorganic fine particles adhering to the toner, the area ratio on the surfaces of the carrier measured by an X-ray analyzer is 0.5 to 3.0 area %.

Japanese Unexamined Patent Application Publication No. 2012-078524 discloses a two-component developer including a toner in which plural external additives having different average primary particle sizes are externally added and, of the plural external additives, at least one external additive has an average primary particle size of 0.1 μm or more, and a resin-covered carrier having carrier cores having a volume-average particle size of 25 μm or more and 90 μm or less and formed of ferrite, and resin cover layers formed on the surfaces of the carrier cores, including magnetic fine particles having a volume-average particle size of 0.1 μm or more and 2 μm or less and a silicone resin, and including 40 parts by weight or more and 100 parts by weight or less of the magnetic fine particles relative to 100 parts by weight of the silicone resin, wherein the mixing ratio of the toner to the resin-covered carrier expressed by a ratio of the total projection area of the toner to the total surface area of the resin-covered carrier is 30% or more and 70% or less.

Japanese Unexamined Patent Application Publication No. 2018-109719 discloses an image forming apparatus having an image carrier having a support body and an amorphous silicon photosensitive layer formed on the surface of the support body, and a developing device having a developer carrier disposed so as to face the image carrier and using a magnetic brush formed on the developer carrier and formed of a two-component developer including a toner and a carrier to develop, in a development region where the image carrier and the developer carrier face each other, an electrostatic latent image on the image carrier to form a toner image, wherein the surface of the photosensitive layer at an initial stage of usage has an arithmetic average roughness Ra in a range of 40 nm or more and 70 nm or less, and the surfaces of the carrier have an arithmetic average roughness Sa in a range of 0.3 μm or more and 1.0 μm or less.

### SUMMARY

Aspects of non-limiting embodiments of the present disclosure relate to, for a carrier including core particles provided by dispersing a magnetic powder in a resin and resin cover layers having a surface coverage of 96 area % or more, compared with cases where the resin cover layers include less than 10 mass % or more than 50 mass % of inorganic particles relative to the total mass of the resin cover layers or the surface exposure ratio of the inorganic particles in the surfaces of the carrier determined by X-ray photoelectron spectroscopy is less than 6 atomic % or more than 15 atomic %, providing an electrostatic image developing carrier that is excellent in later suppression of bead-carry-out of the carrier to the image holding member and later charging rapidness.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an electrostatic image developing carrier including core particles provided by dispersing a magnetic powder in a resin and resin cover layers covering the core particles, wherein the resin cover layers have a surface coverage of 96 area % or more, the resin cover layers include 10 mass % or more and 50 mass % or less of inorganic particles relative to a total mass of the resin cover layers, and the inorganic particles in surfaces of the carrier have a surface exposure ratio of 6 atomic % or more and 15 atomic % or less determined by X-ray photoelectron spectroscopy.

### BRIEF DESCRIPTION OF THE DRAWINGS

Exemplary embodiments of the present disclosure will be described in detail based on the following figures, wherein:

FIG. 1 is a schematic configuration view illustrating an example of an image forming apparatus according to the present exemplary embodiment; and

FIG. 2 is a schematic configuration view illustrating an example of a process cartridge attachable to and detachable from an image forming apparatus according to the present exemplary embodiment.

### DETAILED DESCRIPTION

Hereinafter, exemplary embodiments according to the present exemplary embodiment will be described. These descriptions and Examples are examples of exemplary embodiments and do not limit the scope of exemplary embodiments.

In the present exemplary embodiment, numerical ranges described in the form of “a value ‘to’ another value” each include the value and the other value respectively as the minimum value and the maximum value.

In the present exemplary embodiment, among numerical ranges described in series, the upper limit value or the lower limit value of a numerical range may be replaced by the upper limit value or the lower limit value of one of other numerical ranges described in series. In the present exemplary embodiment, for numerical ranges, the upper limit value or the lower limit value of such a numerical range may be replaced by a value described in Examples.

In the present exemplary embodiment, the term “step” includes not only an independent step, but also a step that is not clearly distinguished from another step but that achieves the intended result of the step.

In the present exemplary embodiment, in the case of describing exemplary embodiments with reference to drawings, the configurations of the exemplary embodiments are not limited to the configurations illustrated in the drawings. In the drawings, the members are schematically drawn in the sizes and the relative size relationships between the members are not limited to these.

In the present exemplary embodiment, components may each include corresponding substances of plural species. In the present exemplary embodiment, for the descriptions of amounts of components in compositions, when, in such a composition, components each include corresponding substances of plural species, such an amount means the total amount of the substances of plural species in the composition unless otherwise specified.

In the present exemplary embodiment, components may each include corresponding particles of plural species. In such a case where, in a composition, components each include corresponding particles of plural species, the particle size of each component means the value of a mixture of the particles of plural species in the composition unless otherwise specified.

In the present exemplary embodiment, “(meth)acrylic” means at least one of acrylic or methacrylic, and “(meth)acrylate” means at least one of acrylate or methacrylate.

In the present exemplary embodiment, “electrostatic image developing toner” may also be referred to as “toner”; “electrostatic image developing carrier” may also be referred to as “carrier”; “electrostatic image developer” may also be referred to as “developer”.

### Electrostatic Image Developing Carrier

An electrostatic image developing carrier according to the present exemplary embodiment (hereafter, may also be simply referred to as “carrier”) includes core particles provided by dispersing a magnetic powder in a resin, and resin cover layers covering the core particles, wherein the resin cover layers have a surface coverage of 96 area % or more, the resin cover layers include 10 mass % or more and 50 mass % or less of inorganic particles relative to the total mass of the resin cover layers, and the inorganic particles in the surfaces of the carrier have a surface exposure ratio of 6 atomic % or more and 15 atomic % or less determined by X-ray photoelectron spectroscopy.

In the present exemplary embodiment, carbon black is not the inorganic particles.

The carrier according to the present exemplary embodiment, in spite of the carrier including polymerized cores, may be excellent in later suppression of bead-carry-out of the carrier to the image holding member and later charging rapidness. This mechanism is inferred as follows.

The core particles provided by dispersing a magnetic powder in a resin (what are called, polymerized cores) have features (due to the production process) of, compared with filled ferrite cores, low specific gravity, a round shape, and low magnetization.

However, polymerized cores, in particular, polymerized cores in which the resin cover layers over the core particles have coverages of 96 area % or more have low specific gravity, light weight, and weak magnetic force and hence cause a problem of large amounts of bead-carry-out of the carrier (BCO) to the photoreceptor; and the polymerized cores have light weight and are round, and hence have low fluidity within the developing device and have low charging rapidness. These have been found by the inventors of the present disclosure.

When the toner remains for a long time within the developing section, exchange of charges between the toner and the carrier continues, so that the external addition state of the toner changes, which inferentially results in a change in the charged state.

In the case of using the electrostatic image developing carrier according to the present exemplary embodiment, the resin cover layers include 10 mass % or more and 50 mass % or less of inorganic particles relative to the total mass of the resin cover layers, so that the resin cover layers may have higher strength and, even under a high load within the developing section, a change in the resistance may be suppressed and bead-carry-out of the carrier to the image holding member at a later stage may be suppressed.

In addition, in the case of using the electrostatic image developing carrier according to the present exemplary embodiment, the inorganic particles in the surfaces of the carrier have a surface exposure ratio of 6 atomic % or more and 15 atomic % or less determined by X-ray photoelectron spectroscopy, so that the carrier may have fine irregularities in the surfaces, the carrier may have higher fluidity to achieve uniform charging, or the fine irregularities may cause orientation subjected to further rubbing, which may result in an increase in the charge amount.

For these reasons, the carrier, in spite of including polymerized cores, may be excellent in later suppression of bead-carry-out of the carrier to the image holding member and later charging rapidness.

Hereinafter, the configuration of a carrier according to the present exemplary embodiment will be described in detail.

### Resin Cover Layers

The electrostatic image developing carrier according to the present exemplary embodiment includes resin cover layers covering the core particles, wherein the resin cover layers have a surface coverage of 96 area % or more, the resin cover layers include 10 mass % or more and 50 mass % or less of inorganic particles relative to the total mass of the resin cover layers, and the inorganic particles in the surfaces of the carrier have a surface exposure ratio of 6 atomic % or more and 15 atomic % or less determined by X-ray photoelectron spectroscopy.

The resin cover layers have a surface coverage of 96 area % or more and, from the viewpoint of initial and later suppression of bead-carry-out of the carrier to the image holding member, preferably 97 area % or more and 100 area % or less, more preferably 98 area % or more and 100 area % or less.

In the carrier according to the present exemplary embodiment, the surface exposure ratio of the inorganic particles in the surfaces of the carrier determined by X-ray photoelectron spectroscopy is 6 atomic % or more and 15 atomic % or less and, from the viewpoint of initial and later charging rapidness, preferably 7 atomic % or more and 13 atomic % or less, more preferably 8 atomic % or more and 11 atomic % or less.

In the carrier according to the present exemplary embodiment, the surface coverage of the resin cover layers and the surface exposure ratio of the inorganic particles are measured in the following manner.

The carrier serving as the sample is analyzed under the following conditions by X-ray photoelectron spectroscopy (XPS) to measure, on the basis of the peak intensities of elements, the iron-element concentration in the surfaces of the carrier (the surface exposure ratio of the core particles) and to determine, on the basis of, for example, the concentration of the silicon element included in the inorganic particles, the surface exposure ratio (atomic %) of the inorganic particles.
XPS apparatus: manufactured by ULVAC-PHI, Inc., VersaProbe II
Etching gun: argon gun
Acceleration voltage: 5 kV
Emission current: 20 mA
Sputtering region: 2 mm×2 mm
Sputtering rate: 3 nm/min (in terms of SiO₂)

On the basis of the iron-element concentration in the surfaces of the carrier (the surface exposure concentration of the core particles), the exposure area of the core particles is calculated; the exposure area is subtracted from the measured area of the carrier to calculate the area of the resin cover layers; furthermore, the surface coverage of the resin cover layers is calculated.

The resin cover layers include, relative to the total mass of the resin cover layers, 10 mass % or more and 50 mass or less of the inorganic particles; from the viewpoint of initial and later suppression of bead-carry-out of the carrier to the image holding member and initial and later charging rapidness, the inorganic particle content is preferably 20 mass % or more and 45 mass % or less, more preferably 30 mass % or more and 40 mass % or less.

From the viewpoint of initial and later suppression of bead-carry-out of the carrier to the image holding member and initial and later charging rapidness, the resin cover layers preferably include silica particles, relative to the total mass of the resin cover layers, in an amount of 10 mass % or more and 50 mass % or less, more preferably 20 mass % or more and 45 mass % or less, particularly preferably 30 mass % or more and 40 mass % or less.

In the present exemplary embodiment, the inorganic particle content in the resin cover layers is measured in the following manner.

In the method of measuring the inorganic particle content in the resin cover layers, 2 g of the carrier separated from the toner in the developer is placed into a 20 mL glass vial and measured in terms of mass. Subsequently, into the glass vial, 15 mL of methyl ethyl ketone is placed and a wave rotor is used to perform stirring for 10 minutes to dissolve the resin cover layers in the solvent. A magnet is used to remove the solvent; furthermore, 10 mL of methyl ethyl ketone is used to wash the carrier cores (core particles) three times. The washed carrier cores are dried and then accurately weighed; the difference from 2 g of the carrier is defined as the mass of the resin cover layers of the carrier. The removed solvent is driven off and the resultant residue corresponds to the mass of the inorganic particles. From the mass of the resin cover layers and the mass of the inorganic particles, the inorganic particle content (mass %) in the resin cover layers of the carrier is calculated.

Examples of the inorganic particles included in the resin cover layers include particles of a metal oxide such as silica, titanium oxide, zinc oxide, or tin oxide; particles of a metal compound such as barium sulfate, aluminum borate, or potassium titanate; and particles of a metal such as gold, silver, or copper.

Of these, from the viewpoint of initial and later suppression of bead-carry-out of the carrier to the image holding member and initial and later charging rapidness, silica particles are preferred.

The arithmetic average particle size of the inorganic particles in the resin cover layers is, from the viewpoint of initial and later suppression of bead-carry-out of the carrier to the image holding member and initial and later charging rapidness, preferably 5 nm or more and 90 nm or less, more preferably 5 nm or more and 70 nm or less, still more preferably 5 nm or more and 50 nm or less, particularly preferably 8 nm or more and 50 nm or less.

In the present exemplary embodiment, the average thickness of the resin cover layers is, from the viewpoint of suppression of change in the density, preferably 0.6 μm or more and 1.4 μm or less, more preferably 0.8 μm or more and 1.2 μm or less, particularly preferably 0.8 μm or more and 1.1 μm or less.

In the present exemplary embodiment, the average particle size of the inorganic particles included in the resin cover layers and the average thickness of the resin cover layers are determined in the following manner.

The carrier is embedded in an epoxy resin and a microtome is used for cutting to form a carrier section. The carrier section is photographed using a scanning electron microscope (SEM) and the resultant SEM image is imported into an image processing analyzer and subjected to image analysis. In the resin cover layers, 100 inorganic particles (primary particles) are randomly selected, and their equivalent circular diameters (nm) are determined and arithmetically averaged to determine the average particle size (nm) of the inorganic particles.

The thicknesses (μm) of the resin cover layer at randomly selected 10 points of a single particle of the carrier are measured; this measurement is further performed for 100 particles of the carrier, and all the measured thicknesses are arithmetically averaged to determine the average thickness (μm) of the resin cover layers.

The inorganic particles may have surfaces having been subjected to a hydrophobizing treatment. Examples of the hydrophobizing agent include publicly known organic silicon compounds having an alkyl group (such as a methyl group, an ethyl group, a propyl group, or a butyl group); specific examples include alkoxysilane compounds, siloxane compounds, and silazane compounds. Of these, the hydrophobizing agent is preferably a silazane compound, preferably hexamethyldisilazane. Such hydrophobizing agents may be used alone or in combination of two or more thereof.

Examples of the method of subjecting the inorganic particles to a hydrophobizing treatment using a hydrophobizing agent include a method of using supercritical carbon dioxide to dissolve a hydrophobizing agent in supercritical carbon dioxide to cause the hydrophobizing agent to adhere to the surfaces of the inorganic particles; a method of performing, in the air, application (for example, spraying or coating) of a solution including a hydrophobizing agent and a solvent in which the hydrophobizing agent dissolves onto the surfaces of the inorganic particles, to cause the hydrophobizing agent to adhere to the surfaces of the inorganic particles; and a method of, in the air, adding, to an inorganic particle dispersion liquid, a solution including a hydrophobizing agent and a solvent in which the hydrophobizing agent dissolves, and holding and subsequently drying the mixed solution of the inorganic particle dispersion liquid and the solution.

Examples of the resin forming the resin cover layers include styrene-acrylic acid copolymers; polyolefin resins such as polyethylene and polypropylene; polyvinyl-based or polyvinylidene-based resins such as polystyrene, acrylic resin, polyacrylonitrile, polyvinyl acetate, polyvinyl alcohol, polyvinyl butyral, polyvinyl chloride, polyvinylcarbazole, polyvinyl ether, and polyvinyl ketone; vinyl chloride-vinyl acetate copolymers; straight silicone resin constituted by organosiloxane bonds or modified resins thereof; fluororesins such as polytetrafluoroethylene, polyvinyl fluoride, polyvinylidene fluoride, and polychlorotrifluoroethylene; polyester; polyurethane; polycarbonate; amino resins such as urea-formaldehyde resin; and epoxy resin.

In particular, the resin forming the resin cover layers, from the viewpoint of chargeability, external additive adhesion controllability, initial and later suppression of bead-carry-out of the carrier to the image holding member, and initial and later charging rapidness, preferably includes acrylic resin, more preferably includes 50 mass % or more of acrylic resin relative to the total resin mass in the resin cover layers, particularly preferably includes 80 mass % or more of acrylic resin relative to the total resin mass in the resin cover layers.

The resin cover layers, from the viewpoint of initial and later suppression of bead-carry-out of the carrier to the image holding member and initial and later charging rapidness, preferably contains an acrylic resin having an alicyclic structure. The polymerizable component for the acrylic resin having an alicyclic structure is preferably a lower alkyl ester of (meth)acrylic acid (such as an alkyl ester of (meth)acrylic acid having an alkyl group having 1 or more and 9 or less carbon atoms); specific examples include methyl (meth)acrylate, ethyl (meth)acrylate, propyl (meth)acrylate, butyl (meth)acrylate, hexyl (meth)acrylate, cyclohexyl (meth)acrylate, and 2-ethylhexyl (meth)acrylate. These monomers may be used alone or in combination of two or more thereof.

The acrylic resin having an alicyclic structure preferably includes, as a polymerizable component, cyclohexyl (meth)acrylate. In the acrylic resin having an alicyclic structure, the content of a monomer unit derived from cyclohexyl (meth)acrylate relative to the total mass of the acrylic resin having an alicyclic structure is preferably 75 mass % or more and 100 mass % or less, more preferably 85 mass % or more and 100 mass % or less, still more preferably 95 mass % or more and 100 mass % or less.

The resin included in the resin cover layers preferably has a weight-average molecular weight of less than 300,000, more preferably less than 250,000, still more preferably 5,000 or more and less than 250,000, particularly preferably 10,000 or more and 200,000 or less. When such a range is satisfied, the resin cover layers may have optimal viscosity to have improved adhesion to the carrier cores, so that separation of the coatings due to the stress in the developing device may be suppressed and hence the carrier may be more excellent in initial and later suppression of bead-carry-out of the carrier to the image holding member and initial and later charging rapidness.

The resin cover layers may include conductive particles for the purpose of controlling charging or resistance. Examples of the conductive particles include carbon black and particles having conductivity among the above-described inorganic particles.

Examples of the process of forming the resin cover layers over the surfaces of the core particles include a wet formation process and a dry formation process. The wet formation process is a formation process of using a solvent in which the resin forming the resin cover layers is dissolved or dispersed. On the other hand, the dry formation process is a formation process of not using the solvent.

Examples of the wet formation process include an immersion process of coating core particles by immersion into a resin-cover-layer-forming resin liquid; a spraying process of spraying a resin-cover-layer-forming resin liquid to the surfaces of core particles; a fluidized bed process of spraying, to core particles being fluidized in a fluidized bed, a resin-cover-layer-forming resin liquid; and a kneader-coater process of mixing, in a kneader-coater, core particles and a resin-cover-layer-forming resin liquid and removing the solvent. Such formation processes may be repeated or combined.

The resin-cover-layer-forming resin liquid used in the wet formation process is prepared by dissolving or dispersing resin, inorganic particles, and another component in a solvent. The solvent is not particularly limited; examples include aromatic hydrocarbons such as toluene and xylene; ketones such as acetone and methyl ethyl ketone; and ethers such as tetrahydrofuran and dioxane.

The dry formation process is, for example, a process of heating a mixture of core particles and a resin-cover-layer-forming resin in a dry state to form resin cover layers. Specifically, for example, core particles and a resin-cover-layer-forming resin are, in a gas phase, mixed and heated to melt, to form resin cover layers.

### Core Particles

The electrostatic image developing carrier according to the present exemplary embodiment includes core particles provided by dispersing a magnetic powder in a resin.

The magnetic powder is not particularly limited, and may be any of publicly known magnetic powders. Specific examples include γ-iron oxide, ferrite, and magnetite; from the viewpoint of high stability, ferrite and magnetite are preferably used; from the viewpoint of being less expensive, magnetite is preferred.

Examples of the ferrite include particles of ferrite represented by the following structural formula.

(MO)_{X}(Fe₂O₃)_{Y} Structural formula:

(In the structural formula, M represents at least one metallic element selected from Cu, Zn, Fe, Mg, Mn, Ca, Li, Ti, Ni, Sn, Sr, Al, Ba, Co, and Mo. X and Y represent a molar ratio and satisfy X+Y=100.)

Examples of the ferrite that has, of structures represented by the above-described structural formula, a structure in which M represents plural metallic elements include iron-based oxides such as Mn—Zn-based ferrite, Ni—Zn-based ferrite, Mn—Mg-based ferrite, Li-based ferrite, and Cu—Zn-based ferrite.

The magnetic powder preferably has a volume-average particle size of 0.01 μm or more and 1 μm or less, more preferably 0.03 μm or more and 0.5 μm or less, particularly preferably 0.05 μm or more and 0.35 μm or less.

In the present exemplary embodiment, the volume-average particle sizes of the magnetic powder, the core particles, and the carrier are values measured using a laser diffraction particle size distribution analyzer LA-700 (manufactured by HORIBA, Ltd.). Specifically, the particle size distribution measured by the analyzer is divided into particle size ranges (channels). Over these channels, a volume-based cumulative curve is drawn from the smaller to larger particle sizes. A particle size corresponding to a cumulative value of 50% is determined as the volume-average particle size.

The method of separating the core particles from the carrier may be a method of using an organic solvent to dissolve the resin cover layers to separate the core particles.

More specifically, the method of separating the core particles from the carrier may be, for example, the following method.

The carrier (20 g) is placed into 100 mL of toluene. Ultrasonic waves at 40 kHz are applied for 30 seconds. A filter paper appropriately selected in accordance with the particle size is used to separate the core particles from the resin solution. The core particles remaining on the filter paper are washed using 20 mL of toluene supplied from above. Subsequently, the core particles remaining on the filter paper are collected. The collected core particles are similarly placed into 100 mL of toluene, and ultrasonic waves at 40 kHz are applied for 30 seconds. Similarly, the core particles are filtered, washed with 20 mL of toluene, and subsequently collected. This procedure is repeated 10 times in total. The core particles finally collected are dried.

The magnetic powder content in the core particles is, from the viewpoint of, for example, formation of particles and suppression of the mechanical load to the toner and the like, preferably 30 mass % or more and 98 mass % or less, more preferably 45 mass % or more and 95 mass or less, particularly preferably 60 mass % or more and 95 mass % or less.

The resin component forming the core particles may be thermoplastic resin or thermosetting resin; examples include resins such as vinyl resin, polyester resin, epoxy resin, phenol resin, urea resin, polyurethane resin, polyimide resin, cellulose resin, silicone resin, acrylic resin, and polyether resin. Such resins may be used alone or in the form of a resin mixture of two or more thereof.

The phenol resin is, for example, a resin obtained by a reaction between a phenol and formaldehyde. The core particles are obtained by, for example, a reaction of ferromagnetic iron compound particles, nonmagnetic iron compound particles, a phenol, and an aldehyde in an aqueous medium in the presence of a basic catalyst.

Examples of the phenol resin include, in addition to phenol itself, compounds having a phenolic hydroxy group such as alkylphenols such as m-cresol, p-tert-butylphenol, o-propylphenol, resorcinol, and bisphenol A, and halogenated phenols in which the benzene nucleus or the alkyl group is partially or wholly substituted with a chlorine atom or a bromine atom; of these, phenol is particularly preferred.

The molar ratio of the aldehyde to the phenol is preferably 1 to 2, particularly preferably 1.1 to 1.6. When the molar ratio of the aldehyde to the phenol is less than 1, spherical composite particles are less likely to be generated and, even when the spherical composite particles are generated, curing of the resin is less likely to proceed and hence the generated particles tend to have low strength. On the other hand, when the molar ratio of the aldehyde to the phenol is more than 2, an increased amount of the unreacted aldehyde tends to remain in the aqueous medium after the reaction.

Examples of the basic catalyst used for the present exemplary embodiment include those ordinarily used in production of resol resin, for example, ammonia water and alkylamines such as hexamethylenetetramine, dimethylamine, diethyltriamine, and polyethyleneimine. The molar ratio of such a basic catalyst to the phenol may be 0.02 or more and 0.3 or less.

During the reaction of the phenol and the aldehyde in the presence of the basic catalyst, the amount of ferromagnetic iron compound particles and nonmagnetic iron compound particles also present in the reaction is preferably 0.5 or more and 200 or less times the weight of the phenol, more preferably 4 or more and 100 or less times the weight of the phenol in consideration of the strength of the spherical composite particles to be generated.

Preferred examples of the vinyl resin include vinyl ether resin and N-vinyl resin. Of these vinyl resins, vinyl ether resin is preferred from the viewpoint of the binding capability.

In particular, from the viewpoint of strength, initial and later suppression of bead-carry-out of the carrier to the image holding member, and initial and later charging rapidness, the resin in the core particles preferably includes a phenol resin, more preferably includes 50 mass % or more of a phenol resin relative to the total resin mass in the resin cover layers, particularly preferably includes 80 mass % or more of a phenol resin relative to the total resin mass in the resin cover layers.

The core particles may further contain another component depending on the purpose. Examples of the other component include a charge control agent and fluorine-containing particles.

The method for producing the core particles is not particularly limited; examples include a melt-kneading method of subjecting the magnetic powder and the resin to melt-kneading using, for example, a Banbury mixer or a kneader, to cooling, subsequently to pulverization, and to classification (Japanese Examined Patent Application Publication No. 59-24416 and Japanese Examined Patent Application Publication No. 8-3679, for example); a suspension polymerization method of dispersing the monomer unit of the binder resin and the magnetic powder in a solvent to prepare a suspension, and polymerizing this suspension (Japanese Unexamined Patent Application Publication No. 5-100493, for example); and a spray drying method of mixing and dispersing the magnetic powder in a resin solution and subjecting the resultant dispersion to spray drying.

The above-described melt-kneading method, suspension polymerization method, and spray drying method each include a step of preparing the magnetic powder in advance by some means, mixing the magnetic powder and a resin solution, and dispersing the magnetic powder in the resin solution.

For the magnetic force of the core particles, the saturation magnetization in a magnetic field of 3,000 Oe is preferably 50 emu/g or more, more preferably 60 emu/g or more. The saturation magnetization is measured using a Vibrating Sample Magnetometer VSMP10-15 (manufactured by Toei Industry Co., Ltd.). The measurement sample is loaded into a cell having an inner diameter of 7 mm and a height of 5 mm, and set to the above-described apparatus. The measurement is performed under application of a magnetic field and the magnetic field strength is swept to 3000 Oe at the maximum. Subsequently, the magnetic field applied is reduced and a hysteresis curve is created on recording paper. From the data of the curve, saturation magnetization, residual magnetization, and coercive force are determined.

The core particles preferably have a volume electric resistivity (volume resistivity) of 1×10⁵ Ω·cm or more and 1×10⁹ Ω·cm or less, more preferably 1×10⁷ Ω·cm or more and 1×10⁹ Ω·cm or less.

The volume electric resistivity (Ω·cm) of the core particles is measured in the following manner. On a surface of a circular jig having 20 cm² electrode plates, the measurement sample is flatly placed to form a layer having a thickness of 1 mm or more and 3 mm or less. On this, one of the above-described 20 cm² electrode plates is placed to sandwich the layer. In order to remove gaps in the measurement sample, a load of 4 kg is applied onto the electrode plate disposed over the layer, and the thickness (cm) of the layer is measured. To the two electrodes over and under the layer, an electrometer and a high voltage power supply are connected. To the two electrodes, a high voltage is applied such that the electric field strength reaches 10^{3.8} V/cm, during which the value (A) of a current flowing is read. The measurement environment is set to have a temperature of 20° C. and a relative humidity of 50%. The formula of the volume electric resistivity (Ω·cm) of the measurement sample is as follows.

R=E×20/(I−I₀)/L

In this formula, R represents the volume electric resistivity (Ω·cm) of the measurement sample, E represents the applied voltage (V), I represents the value (A) of the current, I, represents the value (A) of the current at an applied voltage of 0 V, and L represents the thickness (cm) of the layer. The coefficient 20 is the area (cm²) of the electrode plates.

The volume-average particle size of the carrier is, from the viewpoint of suppression of change in the density, preferably 25 μm or more and 40 μm or less, more preferably 27 μm or more and 38 μm or less, particularly preferably 29 μm or more and 36 μm or less.

### Electrostatic Image Developer

The developer according to the present exemplary embodiment is a two-component developer including the electrostatic image developing carrier according to the present exemplary embodiment and a toner. The toner includes toner particles and, as needed, an external additive.

In the developer, the mixing ratio (mass ratio) of the carrier to the toner is preferably carrier:toner=100:1 to 100:30, more preferably 100:3 to 100:20.

### Toner Particles

The toner particles include, for example, a binder resin and, as needed, a coloring material, a release agent, and another additive.

### Binder Resin

Examples of the binder resin include vinyl-based resins composed of homopolymers of monomers such as styrenes (such as styrene, para-chlorostyrene, and α-methylstyrene), (meth)acrylic acid esters (such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (such as acrylonitrile and methacrylonitrile), vinyl ethers (such as vinyl methyl ether and vinyl isobutyl ether), vinyl ketones (such as vinyl methyl ketone, vinyl ethyl ketone, and vinyl isopropenyl ketone), and olefins (such as ethylene, propylene, and butadiene), or copolymers of a combination of two or more of these monomers.

Other examples of the binder resin include non-vinyl-based resins such as epoxy resin, polyester resin, polyurethane resin, polyamide resin, cellulose resin, polyether resin, and modified rosin, mixtures of these and the above-described vinyl-based resins, and graft polymers obtained by polymerizing vinyl-based monomers in the presence of the foregoing.

These binder resins may be used alone or in combination of two or more thereof.

As the binder resin, polyester resin is preferred.

The polyester resin is, for example, publicly known amorphous polyester resin. As the polyester resin, amorphous polyester resin may be used in combination with crystalline polyester resin. Note that the crystalline polyester resin may be used such that its content relative to the total binder resin is in the range of 2 mass % or more and 40 mass % or less (preferably 2 mass % or more and 20 mass % or less).

The “crystalline” resin has, as measured by differential scanning calorimetry (DSC), not a stepped endothermic change, but a clear endothermic peak; specifically, as measured at a heating rate of 10(° C./min), the endothermic peak has a half width of 10° C. or less.

On the other hand, the “amorphous” resin has a half width of more than 10° C., and has a stepped endothermic change or does not have a clear endothermic peak.

### Amorphous Polyester Resin

The amorphous polyester resin is, for example, a polycondensation product of a polycarboxylic acid and a polyhydric alcohol. The amorphous polyester resin may be a commercially available product or may be synthesized.

Examples of the polycarboxylic acid include aliphatic dicarboxylic acids (such as oxalic acid, malonic acid, maleic acid, fumaric acid, citraconic acid, itaconic acid, glutaconic acid, succinic acid, alkenyl succinic acid, adipic acid, and sebacic acid), alicyclic dicarboxylic acids (such as cyclohexanedicarboxylic acid), aromatic dicarboxylic acids (such as terephthalic acid, isophthalic acid, phthalic acid, and naphthalenedicarboxylic acid), anhydrides of the foregoing, and lower alkyl (having 1 or more and 5 or less carbon atoms, for example) esters of the foregoing. Of these, as the polycarboxylic acid, for example, preferred are aromatic dicarboxylic acids.

As the polycarboxylic acid, in addition to a dicarboxylic acid, a tri- or higher valent carboxylic acid having a crosslinkable structure or a branched structure may be used. Examples of the tri- or higher valent carboxylic acid include trimellitic acid, pyromellitic acid, anhydrides of the foregoing, and lower alkyl (having 1 or more and 5 or less carbon atoms, for example) esters of the foregoing.

Such polycarboxylic acids may be used alone or in combination of two or more thereof.

Examples of the polyhydric alcohol include aliphatic diols (such as ethylene glycol, diethylene glycol, triethylene glycol, propylene glycol, butanediol, hexanediol, and neopentyl glycol), alicyclic diols (such as cyclohexanediol, cyclohexanedimethanol, and hydrogenated bisphenol A), and aromatic diols (such as an ethylene oxide adduct of bisphenol A and a propylene oxide adduct of bisphenol A). Of these, as the polyhydric alcohol, for example, preferred are aromatic diols and alicyclic diols, and more preferred are aromatic diols.

As the polyhydric alcohol, in addition to a diol, a tri- or higher valent polyhydric alcohol having a crosslinkable structure or a branched structure may be used. Examples of the tri- or higher valent polyhydric alcohol include glycerol, trimethylolpropane, and pentaerythritol.

Such polyhydric alcohols may be used alone or in combination of two or more thereof.

The amorphous polyester resin preferably has a glass transition temperature (Tg) of 50° C. or more and 80° C. or less, more preferably 50° C. or more and 65° C. or less.

The glass transition temperature is determined from a differential scanning calorimetry (DSC) curve obtained by DSC, more specifically determined in accordance with “extrapolated glass transition onset temperature” described in “How to determine glass transition temperature” in JIS K7121:1987 “Testing Methods for Transition Temperature of Plastics”.

The amorphous polyester resin preferably has a weight-average molecular weight (Mw) of 5000 or more and 1000000 or less, more preferably 7000 or more and 500000 or less.

The amorphous polyester resin preferably has a number-average molecular weight (Mn) of 2000 or more and 100000 or less.

The amorphous polyester resin preferably has a polydispersity index Mw/Mn of 1.5 or more and 100 or less, more preferably 2 or more and 60 or less.

The weight-average molecular weight and the number-average molecular weight are measured by gel permeation chromatography (GPC). The molecular weight measurement by GPC is performed using, as the measurement apparatus, GPC-HLC-8120GPC manufactured by Tosoh Corporation, using a column manufactured by Tosoh Corporation, TSKgel SuperHM-M (15 cm), and using a THF solvent. The weight-average molecular weight and the number-average molecular weight are calculated on the basis of the measurement results using a molecular weight calibration curve created using monodisperse polystyrene standard samples.

The amorphous polyester resin is obtained by a publicly known production method. Specifically, the method is, for example, a method in which the polymerization temperature is set at 180° C. or more and 230° C. or less, the pressure within the reaction system is reduced as needed, and the reaction is caused while water or alcohol generated during condensation is removed.

When the monomers serving as starting materials do not dissolve or mix under the reaction temperature, a solvent having a high boiling point may be added as a solubilizing agent to achieve dissolution. In this case, the polycondensation reaction is caused while the solubilizing agent is driven off. When the copolymerization reaction is to be performed using a monomer having low miscibility, the monomer having low miscibility and an acid or alcohol used for polycondensation with the monomer may be condensed in advance and then subjected to polycondensation with the main component.

Crystalline Polyester Resin

The crystalline polyester resin is, for example, a polycondensation product between a polycarboxylic acid and a polyhydric alcohol. The crystalline polyester resin may be a commercially available product or may be synthesized.

As the crystalline polyester resin, from the viewpoint of facilitation of formation of a crystalline structure, polycondensation products formed from linear aliphatic polymerizable monomers are preferred, compared with polymerizable monomers having aromatic rings.

Examples of the polycarboxylic acid include aliphatic dicarboxylic acids (such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (for example, dibasic acids such as phthalic acid, isophthalic acid, terephthalic acid, and naphthalene-2,6-dicarboxylic acid), anhydrides of the foregoing, and lower alkyl (having 1 or more and 5 or less carbon atoms, for example) esters of the foregoing.

As the polycarboxylic acid, in addition to a dicarboxylic acid, a tri- or higher valent carboxylic acid having a crosslinkable structure or a branched structure may be used. Examples of the trivalent carboxylic acid include aromatic carboxylic acids (such as 1,2,3-benzenetricarboxylic acid, 1,2,4-benzenetricarboxylic acid, and 1,2,4-naphthalenetricarboxylic acid), anhydrides of the foregoing, and lower alkyl (having 1 or more and 5 or less carbon atoms, for example) esters of the foregoing.

As the polycarboxylic acid, in addition to such a dicarboxylic acid, a dicarboxylic acid having a sulfonic group or a dicarboxylic acid having an ethylenically double bond may be used.

Such polycarboxylic acids may be used alone or in combination of two or more thereof.

Examples of the polyhydric alcohol include aliphatic diols (such as linear aliphatic diols having a main chain moiety having 7 or more and 20 or less carbon atoms). Examples of the aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Of these, preferred aliphatic diols are 1,8-octanediol, 1,9-nonanediol, and 1,10-decanediol.

As the polyhydric alcohol, in addition to a diol, a tri- or higher valent alcohol having a crosslinkable structure or a branched structure may be used. Examples of the tri- or higher valent alcohol include glycerol, trimethylolethane, trimethylolpropane, and pentaerythritol.

Such polyhydric alcohols may be used alone or in combination of two or more thereof.

The polyhydric alcohol may have an aliphatic diol content of 80 mol % or more, preferably 90 mol % or more.

The crystalline polyester resin preferably has a melting temperature of 50° C. or more and 100° C. or less, more preferably 55° C. or more and 90° C. or less, still more preferably 60° C. or more and 85° C. or less.

The melting temperature is determined on the basis of a differential scanning calorimetry (DSC) curve obtained by DSC in accordance with “melting peak temperature” described in “How to determine melting temperature” in JIS K7121:1987 “Testing Methods for Transition Temperature of Plastics”.

The crystalline polyester resin may have a weight-average molecular weight (Mw) of 6,000 or more and 35,000 or less.

The crystalline polyester resin is obtained by, for example, as in the amorphous polyester, a publicly known production method.

The binder resin content relative to the total of the toner particles is preferably 40 mass % or more and 95 mass % or less, more preferably 50 mass % or more and 90 mass % or less, still more preferably 60 mass % or more and 85 mass % or less.

### Coloring Material

Examples of the coloring material include pigments such as carbon black, Chrome Yellow, Hansa yellow, Benzidine Yellow, Threne Yellow, Quinoline Yellow, Pigment Yellow, Permanent Orange GTR, Pyrazolone Orange, Vulcan Orange, Watchung Red, Permanent Red, Brilliant Carmine 3B, Brilliant Carmine 6B, Dupont Oil Red, Pyrazolone Red, Lithol Red, Rhodamine B Lake, Lake Red C, Pigment Red, Rose Bengal, Aniline Blue, Ultramarine Blue, Calco Oil Blue, Methylene Blue chloride, Phthalocyanine Blue, Pigment Blue, Phthalocyanine Green, and Malachite Green Oxalate; and dyes such as acridine-based, xanthene-based, azo-based, benzoquinone-based, azine-based, anthraquinone-based, thioindigo-based, dioxazine-based, thiazine-based, azomethine-based, indigo-based, phthalocyanine-based, aniline black-based, polymethine-based, triphenylmethane-based, diphenylmethane-based, and thiazole-based dyes.

Such coloring materials may be used alone or in combination of two or more thereof.

As the coloring material, a surface-treated coloring material may be used as needed and may be used in combination with a dispersing agent. As the coloring material, plural coloring materials may be used in combination.

The coloring material content relative to the total of the toner particles is preferably 1 mass % or more and 30 mass % or less, more preferably 3 mass % or more and 15 mass % or less.

### Release Agent

Examples of the release agent include hydrocarbon waxes; natural waxes such as carnauba wax, rice wax, and candelilla wax; synthetic or mineral or petroleum waxes such as montan wax; and ester waxes such as fatty acid esters and montanic acid esters. The release agent is not limited to these.

The release agent preferably has a melting temperature of 50° C. or more and 110° C. or less, more preferably 60° C. or more and 100° C. or less.

The melting temperature is determined on the basis of a differential scanning calorimetry (DSC) curve obtained by DSC in accordance with “melting peak temperature” described in “How to determine melting temperature” described in JIS K7121:1987 “Testing Methods for Transition Temperature of Plastics”.

The release agent content relative to the total of the toner particles is preferably 1 mass % or more and 20 mass % or less, more preferably 5 mass % or more and 15 mass % or less.

### Another Additive

Examples of the other additive include publicly known additives such as magnetic substances, charge control agents, and inorganic powders. These additives are included, as internal additives, in toner particles.

Properties Etc. Of Toner Particles

The toner particles may be toner particles having a monolayer structure or toner particles having, what is called, a core-shell structure constituted by a core part (core particle) and a cover layer (shell layer) covering the core part.

The toner particles having a core-shell structure may be constituted by, for example, a core part including a binder resin and optional other additives such as a coloring material and a release agent, and a cover layer including a binder resin.

The toner particles preferably have a volume-average particle size (D50v) of 2 μm or more and 10 μm or less, more preferably 4 μm or more and 8 μm or less.

The volume-average particle size (D50v) of the toner particles is measured using a Coulter Multisizer II (manufactured by Beckman Coulter, Inc.) and using, as the electrolytic solution, ISOTON-II (manufactured by Beckman Coulter, Inc.).

In the measurement, to 2 ml of a 5 mass % aqueous solution of a surfactant (preferably sodium alkylbenzene sulfonate) serving as a dispersing agent, 0.5 mg or more and 50 mg or less of the measurement sample is added. This is added to 100 ml or more and 150 ml or less of the electrolytic solution.

The electrolytic solution in which the sample has been suspended is subjected to dispersing treatment for 1 minute using an ultrasonic dispersing machine, and Coulter Multisizer II is used with an aperture having an aperture diameter of 100 μm to measure the particle size distribution of particles having a particle size in the range of 2 μm or more and 60 μm or less. The number of particles sampled is 50000. A volume-based particle size distribution curve is drawn from the smaller to larger particle sizes, and a particle size corresponding to a cumulative value of 50% is determined as volume-average particle size D50v.

The toner particles preferably have an average circularity of 0.94 or more and 1.00 or less, more preferably 0.95 or more and 0.98 or less.

The average circularity of the toner particles is determined by (circumference of equivalent circle)/(circumference) [(circumference of circle having the same projection area as in image of particle)/(circumference of projection image of particle)]. Specifically, the average circularity is a value measured in the following manner.

First, toner particles to be measured are sampled by suctioning and caused to form a flat flow; a stroboscope is caused to flash momentarily to obtain, as a still picture, the image of particles, and the image of particles is subjected to image analysis using a flow particle image analyzer (FPIA-3000 manufactured by SYSMEX CORPORATION) to determine the average circularity. The number of particles sampled for determining average circularity is 3500.

When the toner includes an external additive, the toner (developer) to be measured is dispersed in water including a surfactant, and subsequently subjected to ultrasonic treatment to obtain toner particles from which the external additive has been removed.

### Method for Producing Toner Particles

The toner particles may be produced by a dry production method (such as a kneading-pulverization method) or a wet production method (such as an aggregation-coalescence method, a suspension polymerization method, or a dissolution-suspension method). For these production methods, limitations are not particularly placed and publicly known production methods are employed. Of these, the aggregation-coalescence method is preferably performed to obtain the toner particles.

Specifically, for example, in the case of producing the toner particles by the aggregation-coalescence method, the following steps are performed to produce the toner particles: a step of preparing a resin-particle dispersion liquid in which resin particles that are to serve as a binder resin are dispersed (resin-particle-dispersion-liquid preparation step); a step of aggregating, in the resin-particle dispersion liquid (or in a dispersion liquid provided by mixing the resin-particle dispersion liquid with another particle dispersion liquid as needed), the resin particles (and the other particles as needed) to form aggregate particles (aggregate-particle formation step); and a step of heating the aggregate-particle dispersion liquid in which the aggregate particles are dispersed, to fuse and coalesce the aggregate particles, to form the toner particles (fusion-coalescence step).

Hereinafter, the steps will be described in detail.

In the following descriptions, the method for obtaining toner particles including a coloring material and a release agent will be described; however, the coloring material and the release agent are used as needed. It is appreciated that another additive other than the coloring material and the release agent may be used.

### Resin-Particle-Dispersion-Liquid Preparation Step

In addition to a resin-particle dispersion liquid in which resin particles that are to serve as a binder resin are dispersed, for example, a coloring-material-particle dispersion liquid in which coloring material particles are dispersed and a release-agent-particle dispersion liquid in which release agent particles are dispersed are prepared.

The resin-particle dispersion liquid is prepared by, for example, dispersing resin particles using a surfactant in a dispersion medium.

Examples of the dispersion medium used for the resin-particle dispersion liquid include aqueous media.

Examples of the aqueous media include waters such as distilled water and ion-exchanged water and alcohols. These may be used alone or in combination of two or more thereof.

Examples of the surfactant include anionic surfactants such as sulfuric acid ester salt-based, sulfonic acid salt-based, phosphoric acid ester-based, and soap-based surfactants; cationic surfactants such as amine salt-type and quaternary ammonium salt-type surfactants; and nonionic surfactants such as polyethylene glycol-based, alkylphenol ethylene oxide adduct-based, and polyhydric alcohol-based surfactants. Of these, in particular, anionic surfactants and cationic surfactants may be used. Such a nonionic surfactant may be used in combination with an anionic surfactant or a cationic surfactant.

Such surfactants may be used alone or in combination of two or more thereof.

For the resin-particle dispersion liquid, examples of the method of dispersing resin particles in a dispersion medium include ordinary dispersing methods using a rotary-shearing homogenizer or a media-equipped ball mill, sand mill, or DYNO-MILL, for example. Alternatively, depending on the type of the resin particles, a phase inversion emulsification method may be performed to disperse the resin particles in a dispersion medium. The phase inversion emulsification method is a method of dissolving the resin to be dispersed, in a hydrophobic organic solvent in which the resin is soluble, adding a base to the organic continuous phase (O phase) to achieve neutralization, and subsequently adding an aqueous medium (W phase) to cause phase inversion from W/O to O/W, to achieve dispersing of the resin in the form of particles in the aqueous medium.

The resin particles dispersed in the resin-particle dispersion liquid preferably have a volume-average particle size of, for example, 0.01 μm or more and 1 μm or less, more preferably 0.08 μm or more and 0.8 μm or less, still more preferably 0.1 μm or more and 0.6 μm or less.

For the volume-average particle size of the resin particles, a laser diffraction particle size distribution analyzer (such as LA-700 manufactured by HORIBA, Ltd.) is used for measurement to obtain a particle size distribution. The particle size distribution is divided into particle size ranges (channels). Over these channels, a volume-based cumulative curve is drawn from the smaller to larger particle sizes. The particle size corresponding to a cumulative value of 50% relative to the whole particles is measured as volume-average particle size D50v. Similarly, the volume-average particle sizes of particles in other dispersion liquids are also measured.

In the resin-particle dispersion liquid, the resin particle content is preferably 5 mass or more and 50 mass % or less, more preferably 10 mass % or more and 40 mass % or less.

As with the resin-particle dispersion liquid, for example, the coloring-material-particle dispersion liquid and the release-agent-particle dispersion liquid are prepared. Specifically, in the resin-particle dispersion liquid, the volume-average particle size of the particles, the dispersion medium, the dispersing method, and the particle content also apply to the coloring material particles dispersed in the coloring-material-particle dispersion liquid and the release agent particles dispersed in the release-agent-particle dispersion liquid.

### Aggregate-Particle Formation Step

Subsequently, the resin-particle dispersion liquid, the coloring-material-particle dispersion liquid, and the release-agent-particle dispersion liquid are mixed together.

Subsequently, in the mixed dispersion liquid, hetero-aggregation of the resin particles, the coloring material particles, and the release agent particles is caused to form aggregate particles including the resin particles, the coloring material particles, and the release agent particles and having diameters close to the diameters of the target toner particles.

Specifically, for example, an aggregating agent is added to the mixed dispersion liquid and the mixed dispersion liquid is adjusted in terms of pH so as to be acidic (such as a pH of 2 or more and 5 or less), and a dispersion stabilizing agent is added as needed; subsequently, the mixed dispersion liquid is heated to a temperature close to the glass transition temperature of the resin particles (specifically, for example, a temperature of “the glass transition temperature of the resin particles−30° C.” or more and “the glass transition temperature−10° C.” or less), to aggregate the particles dispersed in the mixed dispersion liquid, to form aggregate particles.

Alternatively, the aggregate-particle formation step may be performed in the following manner: for example, under stirring of the mixed dispersion liquid using a rotary-shearing homogenizer, an aggregating agent is added at room temperature (for example, 25° C.), the mixed dispersion liquid is adjusted in terms of pH so as to be acidic (such as a pH of 2 or more and 5 or less), and a dispersion stabilizing agent is added as needed; and, subsequently, heating is performed.

Examples of the aggregating agent include surfactants having a polarity opposite to that of the surfactant included in the mixed dispersion liquid, inorganic metal salts, and di- or higher valent metal complexes. In the case of using, as the aggregating agent, a metal complex, the amount of surfactant used may be reduced and charging characteristics may be improved.

Together with the aggregating agent, an additive that forms a complex or a similar bond with the metal ion of the aggregating agent may be used as needed. As this additive, a chelating agent may be used.

Examples of the inorganic metal salts include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

As the chelating agent, a water-soluble chelating agent may be used. Examples of the chelating agent include oxycarboxylic acids such as tartaric acid, citric acid, and gluconic acid; and aminocarboxylic acids such as iminodiacetic acid (IDA), nitrilotriacetic acid (NTA), and ethylenediaminetetraacetic acid (EDTA).

The amount of chelating agent added relative to 100 parts by mass of the resin particles is preferably 0.01 parts by mass or more and 5.0 parts by mass or less, more preferably 0.1 parts by mass or more and less than 3.0 parts by mass.

### Fusion-Coalescence Step

Subsequently, the aggregate-particle dispersion liquid in which the aggregate particles are dispersed is heated to, for example, the glass transition temperature or more of the resin particles (for example, a temperature 10° C. to 30° C. higher than the glass transition temperature of the resin particles), to fuse and coalesce the aggregate particles, to form toner particles.

The above-described steps are performed to provide toner particles.

Alternatively, the toner particles may be produced by performing a step of, after preparation of the aggregate-particle dispersion liquid in which the aggregate particles are dispersed, further mixing the aggregate-particle dispersion liquid and a resin-particle dispersion liquid in which resin particles are dispersed, to cause aggregation such that the resin particles further adhere to the surfaces of the aggregate particles, to form secondary aggregate particles; and a step of heating the secondary-aggregate-particle dispersion liquid in which the secondary aggregate particles are dispersed, to fuse and coalesce the secondary aggregate particles, to form toner particles having a core-shell structure.

After completion of the fusion-coalescence step, the toner particles formed in the solution are subjected to publicly known steps including a washing step, a solid-liquid separation step, and a drying step to obtain dry toner particles. As the washing step, from the viewpoint of chargeability, displacement washing using ion-exchanged water may be sufficiently performed. As the solid-liquid separation step, from the viewpoint of productivity, for example, suction filtration or pressure filtration may be performed. As the drying step, from the viewpoint of productivity, for example, freeze drying, flash drying, fluidized-bed drying, or vibrating fluidized-bed drying may be performed.

The toner according to the present exemplary embodiment is produced by, for example, adding and mixing an external additive with the obtained dry toner particles. The mixing may be performed using, for example, a V blender, a Henschel mixer, or a Loedige mixer. Furthermore, as needed, for example, a vibratory classifier or an air classifier may be used to remove coarse particles from the toner.

### External Additive

Examples of the external additive include inorganic particles. The inorganic particles are formed of SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, or MgSO₄, for example.

The inorganic particles serving as the external additive may have surfaces having been subjected to hydrophobizing treatment. The hydrophobizing treatment is performed by, for example, immersing inorganic particles in a hydrophobizing agent. The hydrophobizing agent is not particularly limited, and examples include silane-based coupling agents, silicone oil, titanate-based coupling agents, and aluminum-based coupling agents. These may be used alone or in combination of two or more thereof.

The amount of hydrophobizing agent is ordinarily, for example, relative to 100 parts by mass of inorganic particles, 1 part by mass or more and 10 parts by mass or less.

Other examples of the external additive include resin particles (resin particles of polystyrene, polymethyl methacrylate, or melamine resin, for example), and cleaning active agents (such as metal salts of higher fatty acids represented by zinc stearate, and particles of fluoropolymers).

The amount of external additive externally added relative to toner particles is preferably 0.01 mass % or more and 5 mass % or less, more preferably 0.01 mass % or more and 2.0 mass % or less.

### Image Forming Apparatus and Image Forming Method

The image forming apparatus according to the present exemplary embodiment includes an image holding member, a charging section configured to charge the surface of the image holding member, an electrostatic image forming section configured to form, on the charged surface of the image holding member, an electrostatic image, a developing section housing an electrostatic image developer and configured to develop, using the electrostatic image developer, the electrostatic image formed on the surface of the image holding member to form a toner image, a transfer section configured to transfer, the toner image formed on the surface of the image holding member onto the surface of a recording medium, and a fixing section configured to fix the transferred toner image on the surface of the recording medium. As the electrostatic image developer, the electrostatic image developer according to the present exemplary embodiment is applied.

In the image forming apparatus according to the present exemplary embodiment, an image forming method (the image forming method according to the present exemplary embodiment) including the following steps is performed: a charging step of charging the surface of the image holding member; an electrostatic-image formation step of forming, on the charged surface of the image holding member, an electrostatic image; a development step of developing, using the electrostatic image developer according to the present exemplary embodiment, the electrostatic image formed on the surface of the image holding member, to form a toner image; a transfer step of transferring the toner image formed on the surface of the image holding member onto the surface of a recording medium; and a fixing step of fixing the transferred toner image on the surface of the recording medium.

As the image forming apparatus according to the present exemplary embodiment, a publicly known image forming apparatus is applied such as a direct transfer mode apparatus configured to directly transfer a toner image formed on the surface of an image holding member onto a recording medium; an intermediate transfer mode apparatus configured to perform first transfer of the toner image formed on the surface of the image holding member onto the surface of an intermediate transfer body, and to perform second transfer of the transferred toner image on the surface of the intermediate transfer body onto the surface of a recording medium; an apparatus including a cleaning section configured to, after transfer of the toner image, clean the surface (to be charged) of the image holding member; or an apparatus including a discharging section configured to, after transfer of the toner image, irradiate the surface (to be charged) of the image holding member with discharging light to achieve discharging.

When the image forming apparatus according to the present exemplary embodiment is an intermediate transfer mode apparatus, the transfer section has, for example, a configuration including an intermediate transfer body on the surface of which the toner image is transferred, a first transfer section configured to perform first transfer of the toner image formed on the surface of the image holding member onto the surface of the intermediate transfer body, and a second transfer section configured to perform second transfer of the transferred toner image on the surface of the intermediate transfer body, onto the surface of a recording medium.

In the image forming apparatus according to the present exemplary embodiment, for example, the part including the developing section may have a cartridge structure (process cartridge) attachable to and detachable from the image forming apparatus. The process cartridge may be, for example, a process cartridge that houses the electrostatic image developer according to the present exemplary embodiment and includes the developing section.

In the image forming method according to the present exemplary embodiment and the image forming apparatus according to the present exemplary embodiment, the rotation speed of the developing roller (what is called, the process speed) may be 40 rpm (revolutions per minute) or more and 120 rpm or less. When this range is satisfied, the image formation is performed under a condition of high load to the developer in the developing device and advantages according to the present exemplary embodiment may be further exerted.

Hereinafter, a non-limiting example of the image forming apparatus according to the present exemplary embodiment will be described. In the following descriptions, some sections in the drawing will be described, but the other portions will not be described.

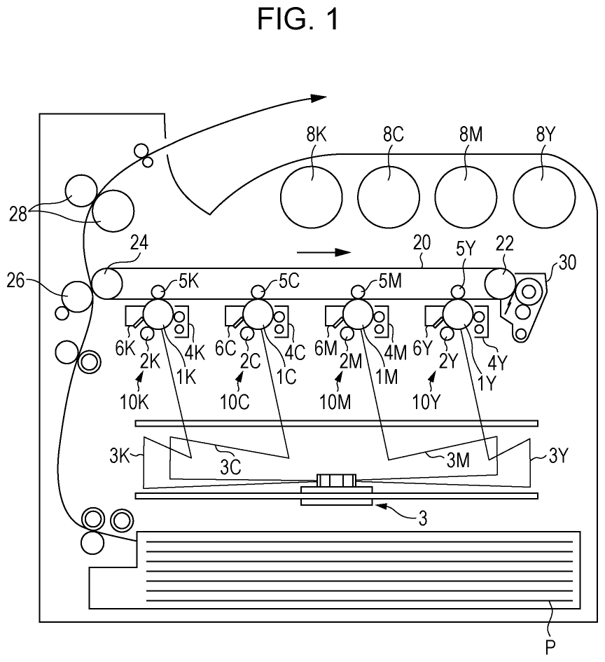

FIG. 1 is a schematic configuration view illustrating the image forming apparatus according to the present exemplary embodiment.

The image forming apparatus in FIG. 1 includes electrophotographic-system first to fourth image formation units 10Y, 10M, 10C, and 10K (image formation sections) configured to output images of individual colors of yellow (Y), magenta (M), cyan (C), and black (K) on the basis of color-separation image data. These image formation units (hereafter, may also be simply referred to as “units”) 10Y, 10M, 10C, and 10K are arranged in the horizontal direction so as to be separated from each other at predetermined intervals. These units 10Y, 10M, 10C, and 10K may be process cartridges attachable to and detachable from the image forming apparatus.

In upper portions of the units 10Y, 10M, 10C, and 10K, an intermediate transfer belt (an example of the intermediate transfer body) 20 is disposed so as to extend through the units. The intermediate transfer belt 20 is wrapped around a driving roller 22 and a support roller 24 so as to be run in a direction from the first unit 10Y to the fourth unit 10K. The support roller 24 is urged by, for example, a spring (not shown) in a direction away from the driving roller 22, so that the intermediate transfer belt 20 wrapped around the rollers is stretched. On the image holding member-side surface of the intermediate transfer belt 20, an intermediate-transfer-body cleaning device 30 is disposed so as to face the driving roller 22.

To developing devices (examples of the developing section) 4Y, 4M, 4C, and 4K of the units 10Y, 10M, 10C, and 10K, yellow, magenta, cyan, and black toners housed in toner cartridges 8Y, 8M, 8C, and 8K are respectively supplied.

The first to fourth units 10Y, 10M, 10C, and 10K have the same configuration and operations, and hence the first unit 10Y disposed upstream in the running direction of the intermediate transfer belt and configured to form a yellow image will be described as a representative.

The first unit 10Y includes a photoreceptor 1Y serving as an image holding member. Around the photoreceptor 1Y, the following are sequentially disposed: a charging roller (an example of the charging section) 2Y configured to charge the surface of the photoreceptor 1Y to a predetermined potential; an exposure device (an example of the electrostatic image forming section) 3 configured to use a laser beam 3Y on the basis of color-separation image signals to expose the charged surface to form an electrostatic image; a developing device (an example of the developing section) 4Y configured to supply the charged toner to the electrostatic image to develop the electrostatic image; a first transfer roller 5Y (an example of the first transfer section) configured to transfer the developed toner image onto the intermediate transfer belt 20; and a photoreceptor cleaning device (an example of the cleaning section) 6Y configured to remove, after the first transfer, the residual toner on the surface of the photoreceptor 1Y.

The first transfer roller 5Y is disposed inside of the intermediate transfer belt 20 and at a position so as to face the photoreceptor 1Y. To the first transfer rollers 5Y, 5M, 5C, and 5K of the units, bias power supplies (not shown) configured to apply first transfer biases are individually connected. Each bias power supply applies a transfer bias variable under control by a controller (not shown), to the first transfer roller.

Hereinafter, in the first unit 10Y, the operations of forming a yellow image will be described.

First, before the operations, the charging roller 2Y charges the surface of the photoreceptor 1Y to a potential of −600 V to −800 V.

The photoreceptor 1Y is formed by forming, on a conductive (for example, a volume resistivity at 20° C. of 1×10⁻⁶ Ωcm or less) base body, a photosensitive layer. This photosensitive layer has properties of normally having high resistivity (resistivity of ordinary resin), but, upon irradiation with a laser beam, having laser-beam irradiation portions having a different resistivity. Thus, the charged surface of the photoreceptor 1Y is irradiated with the laser beam 3Y from the exposure device 3 in accordance with the yellow image data transmitted from the controller (not shown). This forms an electrostatic image having the yellow image pattern on the surface of the photoreceptor 1Y.

The electrostatic image is an image formed on the surface of the photoreceptor 1Y by charging: the laser beam 3Y causes a decrease in the resistivity of the irradiated portions of the photosensitive layer where charges flow out from the charged surface of the photoreceptor 1Y while charges of the portions not irradiated with the laser beam 3Y remain, which results in formation of, what is called, a negative latent image.

The electrostatic image formed on the photoreceptor 1Y is rotated together with running of the photoreceptor 1Y to the predetermined development position. At this development position, the electrostatic image on the photoreceptor 1Y is developed and visualized by the developing device 4Y to form a toner image.

The developing device 4Y houses therein, for example, an electrostatic image developer including at least a yellow toner and a carrier. The yellow toner is stirred within the developing device 4Y to thereby be frictionally charged, and is held on the developer roller (an example of the developer holding member) so as to have charges having the same polarity (negative polarity) as in the charges on the charged photoreceptor 1Y. While the surface of the photoreceptor 1Y passes over the developing device 4Y, the yellow toner electrostatically adheres to the discharged latent image portions on the surface of the photoreceptor 1Y, so that the latent image is developed with the yellow toner. The photoreceptor 1Y having the yellow toner image formed is continuously run at the predetermined speed, to convey the developed toner image on the photoreceptor 1Y to the predetermined first transfer position.

When the yellow toner image on the photoreceptor 1Y is conveyed to the first transfer position, a first transfer bias is applied to the first transfer roller 5Y, an electrostatic force from the photoreceptor 1Y toward the first transfer roller 5Y affects the toner image, so that the toner image on the photoreceptor 1Y is transferred onto the intermediate transfer belt 20. The transfer bias applied at this time has a polarity (+) opposite to the polarity (−) of the toner, and is controlled to be, for example, +10 μA at the first unit 10Y by a controller (not shown).

On the other hand, the toner remaining on the photoreceptor 1Y is removed by the photoreceptor cleaning device 6Y and collected.

The first transfer biases applied to the first transfer rollers 5M, 5C, and 5K disposed in the second unit 10M and its downstream units are also controlled as in the first unit.

Thus, the intermediate transfer belt 20 onto which the yellow toner image has been transferred at the first unit 10Y is conveyed sequentially through the second to the fourth units 10M, 10C, and 10K, to perform multiple transfer of the toner images of the colors so as to be stacked.

The intermediate transfer belt 20 on which multiple transfer of the toner images of the four colors has been performed at the first to the fourth units reaches a second transfer unit constituted by the intermediate transfer belt 20, the support roller 24 in contact with the inner surface of the intermediate transfer belt, and a second transfer roller (an example of the second transfer section) 26 disposed on the image-holding-surface side of the intermediate transfer belt 20. On the other hand, a recording paper (an example of the recording medium) P is fed at a predetermined timing by a feeding mechanism to the gap where the second transfer roller 26 and the intermediate transfer belt 20 are in contact with each other, and a second transfer bias is applied to the support roller 24. The transfer bias applied at this time has a polarity (−) the same as the polarity (−) of the toner, and the electrostatic force from the intermediate transfer belt 20 toward the recording paper P affects the toner image, to transfer the toner image on the intermediate transfer belt 20 onto the recording paper P. The second transfer bias at this time is determined in response to the resistance of the second transfer unit detected by the resistance detection unit (not shown), and controlled on the basis of voltage.

Subsequently, the recording paper P is sent into the press region (nip) of the pair of fixing rollers in the fixing device (an example of the fixing section) 28, so that the toner image is fixed on the recording paper P, to form a fixed image.

Examples of the recording paper P onto which the toner image is transferred include plain paper used for electrophotographic-system copying machines and printers, for example. Examples of the recording medium include, in addition to the recording paper P, OHP sheets.

In order to further improve the smoothness of the surface of the fixed image, the recording paper P may have a smooth surface and, for example, the coat paper provided by coating the surface of the plain paper with, for example, resin and the art paper for printing may be used.

The recording paper P on which the color image has been fixed is conveyed to the exit unit, and the series of the color image formation operations is completed.

### Process Cartridge

The process cartridge according to the present exemplary embodiment is a process cartridge that houses the electrostatic image developer according to the present exemplary embodiment, includes a developing section configured to develop, using the electrostatic image developer, an electrostatic image formed on the surface of an image holding member, to form a toner image, and is attachable to and detachable from an image forming apparatus.

The process cartridge according to the present exemplary embodiment is not limited to the above-described configuration, and may have a configuration including the developing section and, as needed, another section, for example, at least one selected from other sections such as an image holding member, a charging section, an electrostatic image forming section, and a transfer section.

Hereinafter, a non-limiting example of the process cartridge according to the present exemplary embodiment will be described. In the following descriptions, some sections illustrated in the drawing will be described, but the other portions will not be described.

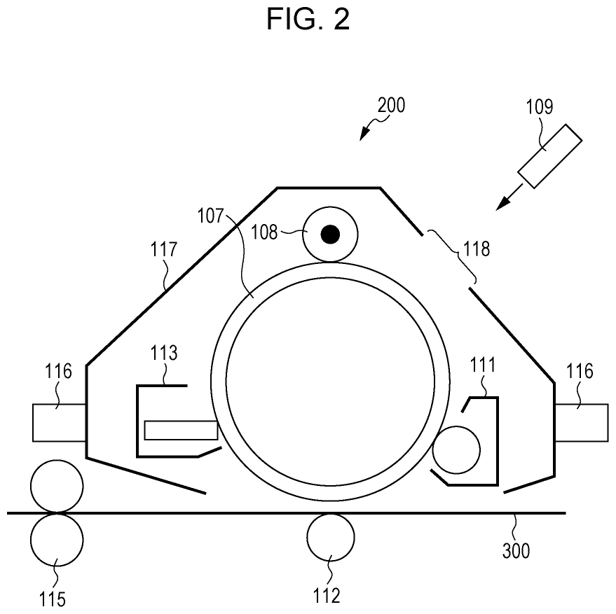

FIG. 2 is a schematic configuration view illustrating the process cartridge according to the present exemplary embodiment.

In a process cartridge 200 in FIG. 2, for example, an attachment rail 116 and a housing 117 having an opening 118 for exposure to light are used to integrally combine and hold a photoreceptor 107 (an example of the image holding member) and a charging roller 108 (an example of the charging section), a developing device 111 (an example of the developing section), and a photoreceptor cleaning device 113 (an example of the cleaning section) that are disposed around the photoreceptor 107, to provide a cartridge.

FIG. 2 illustrates an exposure device 109 (an example of the electrostatic image forming section), a transfer device 112 (an example of the transfer section), a fixing device 115 (an example of the fixing section), and a recording paper 300 (an example of the recording medium).

### EXAMPLES

Hereinafter, exemplary embodiments according to the disclosure will be described in detail with reference to Examples; however, exemplary embodiments according to the disclosure are not limited to these Examples. In the following descriptions, “parts” and “%” are based on mass unless otherwise specified.

In the following descriptions, the volume-average particle size means a particle size D50v corresponding to a cumulative value of 50% in a volume-based particle size distribution curve drawn from the smaller to larger particle sizes.

### Preparation of Toner

### Preparation of Coloring-Material-Particle Dispersion Liquid 1

Cyan pigment (copper phthalocyanine, C.I. Pigment Blue 15:3, manufactured by Dainichiseika Color & Chemicals Mfg. Co., Ltd.): 50 parts by mass

Anionic surfactant: Neogen SC (manufactured by DAI-ICHI KOGYO SEIYAKU CO., LTD.), 5 parts by mass

Ion-exchanged water: 200 parts by mass

The above-described components are mixed, and dispersed using an ULTRA-TURRAX manufactured by IKA-Werke GmbH & Co. KG for 5 minutes and further using an ultrasonic bath for 10 minutes, to obtain Coloring-material-particle dispersion liquid 1 having a solid content of 21%. A particle size analyzer LA-700 manufactured by HORIBA, Ltd. is used to measure the volume-average particle size and it is found to be 160 nm.

### Preparation of Release-Agent-Particle Dispersion Liquid 1

Paraffin wax (HNP-9, manufactured by NIPPON SEIRO CO., LTD.): 19 parts by mass

Anionic surfactant (Neogen SC, manufactured by DAI-ICHI KOGYO SEIYAKU CO., LTD.): 1 part by mass

Ion-exchanged water: 80 parts by mass

The above-described components are mixed together within a heat-resistant container, heated to 90° C., and stirred for 30 minutes. Subsequently, the molten liquid is passed from the bottom of the container through a Gaulin homogenizer, subjected to, under a pressure condition of 5 MPa, circulation processes corresponding to 3 passes, and subsequently subjected to, under an increased pressure of 35 MPa, circulation processes corresponding to 3 passes. The resultant emulsion is cooled in the heat-resistant container to 40° C. or less, to obtain Release-agent-particle dispersion liquid 1. A particle size analyzer LA-700 manufactured by HORIBA, Ltd. is used to measure the volume-average particle size and it is found to be 240 nm.

### Resin-Particle Dispersion Liquid 1

### Oil Layer

Styrene (manufactured by FUJIFILM Wako Pure Chemical Corporation): 30 parts by mass

n-Butyl acrylate (manufactured by FUJIFILM Wako Pure Chemical Corporation): 10 parts by mass

β-Carboxyethyl acrylate (manufactured by Rhodia Nicca, Ltd.): 1.3 parts by mass

Dodecanethiol (manufactured by FUJIFILM Wako Pure Chemical Corporation): 0.4 parts by mass

### Aqueous Layer 1

Ion-exchanged water: 17 parts by mass

Anionic surfactant (Dowfax, manufactured by The Dow Chemical Company): 0.4 parts by mass

Aqueous layer 2

Ion-exchanged water: 40 parts by mass

Anionic surfactant (Dowfax, manufactured by The Dow Chemical Company): 0.05 parts by mass

Ammonium peroxodisulfate (manufactured by FUJIFILM Wako Pure Chemical Corporation): 0.4 parts by mass

The above-described oil-layer components and Aqueous-layer-1 components are placed into a flask and mixed by stirring to provide a monomer emulsion-dispersion liquid. Into a reaction vessel, the above-described Aqueous-layer-2 components are placed; the vessel is sufficiently purged with nitrogen, and heated under stirring in an oil bath until the internal temperature of the reaction system reaches 75° C. Into the reaction vessel, the above-described monomer emulsion-dispersion liquid is gradually added dropwise over 3 hours to cause emulsion polymerization. After the dropwise addition is complete, polymerization at 75° C. is further continued, and the polymerization is completed after the lapse of 3 hours.

For the resultant resin particles, a laser diffraction particle size distribution analyzer LA-700 (manufactured by HORIBA, Ltd.) is used for measurement and, as a result, the volume-average particle size D50v of the resin particles is found to be 250 nm; a differential scanning calorimeter (DSC-50, manufactured by SHIMADZU CORPORATION) is used for measurement and, as a result, the glass transition temperature of the resin at a heating rate of 10° C./min is found to be 53° C.; and a molecular weight measurement device (HLC-8020, manufactured by Tosoh Corporation) is used for measurement and, as a result, the number-average molecular weight (polystyrene equivalent) using THF as the solvent is found to be 13,000. Thus, the obtained resin-particle dispersion liquid has a volume-average particle size of 250 nm, a solid content of 42%, a glass transition temperature of 52° C., and a number-average molecular weight Mn of 13,000.

### Preparation of Toner 1

Resin-particle dispersion liquid: 150 parts by mass

Coloring-material-particle dispersion liquid: 30 parts by mass

Release-agent-particle dispersion liquid: 40 parts by mass

Polyaluminum chloride: 0.4 parts by mass

The above-described components are sufficiently mixed and dispersed in a stainless steel flask using an ULTRA-TURRAX manufactured by IKA-Werke GmbH & Co. KG, and subsequently heated to 48° C. in a heating oil bath under stirring of the flask. After the flask is held at 48° C. for 80 minutes, into the flask, 70 parts by mass of the same resin-particle dispersion liquid as above is gently added.

Subsequently, an aqueous sodium hydroxide solution having a concentration of 0.5 mol/L is used to adjust the pH of the system to 6.0; subsequently, the stainless steel flask is sealed; the sealing of the stirring shaft is magnetically sealed and the flask, under stirring, is heated to 97° C. and held for 3 hours. After the reaction is completed, the content is cooled at a cooling rate of 1° C./min, filtered, sufficiently washed with ion-exchanged water, and subsequently subjected to solid-liquid separation by Nutsche suction filtration. The resultant solid is further dispersed again in 3,000 parts by mass of ion-exchanged water at 40° C., and stirred and washed for 15 minutes at 300 rpm. This washing procedure is further repeated 5 times; at the time when the filtrate has a pH of 6.54 and an electric conductivity of 6.5 μS/cm, Nutsche suction filtration is performed using No. 5A filter paper to achieve solid-liquid separation. Subsequently, vacuum drying is performed over 12 hours to obtain toner base particles.

The toner base particles are measured using a Coulter counter and the volume-average particle size D50v is found to be 6.2 μm, and the volume-average particle size distribution index GSDv is found to be 1.20. The shape of the particles is observed using a LUZEX image analyzer manufactured by NIRECO CORPORATION, and the particles are found to have a shape factor SF1 of 135 and have potato shapes. The glass transition temperature of the toner is found to be 52° C. Furthermore, to this toner, silica (SiO₂) particles having surfaces having been subjected to hydrophobizing treatment using hexamethyldisilazane (hereafter, may be abbreviated as “HMDS”) and having an average primary particle size of 40 nm and metatitanic acid compound particles being a reaction product of metatitanic acid and isobutyltrimethoxysilane and having an average primary particle size of 20 nm are added such that the coverage of the surfaces of the toner particles becomes 40%, and mixed using a Henschel mixer, to prepare Toner 1.

### Preparation of Core Particles 1

To each of a magnetite powder having a number-average particle size of 0.30 μm and a hematite powder having a number-average particle size of 0.30 μm, 4.0 mass % of a silane-based coupling agent (3-(2-aminoethylamino)propyltrimethoxysilane) is added; the powders within the vessels are mixed by stirring at a high rate at 100° C. or more, to treat the particles.

Phenol resin: 10 parts by mass

Formaldehyde solution (formaldehyde: 40%, methanol: 10%, water: 50%): 6 parts by mass

Treated magnetite: 84 parts by mass

The phenol resin is obtained by a reaction between phenol and formaldehyde, and has a three-dimensional network structure.

The above-described materials, 5 parts by mass of 28% ammonia water, and 20 parts by mass of water are placed into a flask, heated to 85° C. over 30 minutes under stirring and mixing and held, and undergone a polymerization reaction for 3 hours, to cure the generated phenol resin. Subsequently, the cured phenol resin is cooled to 30° C., and water is further added; subsequently, the supernatant fluid is removed, and the precipitate is rinsed with water and subsequently air-dried. Subsequently, this is dried under a reduced pressure (5 mmHg or less) at 180° C. for 5 hours, to obtain spherical magnetic carrier core particles 1 in which the magnetic material is dispersed. The resultant cores are found to have a volume-average particle size of 34.0 nm.

### Preparation of Core Particles 2

Core particles 2 are obtained as with Cores 1 except that the phenol resin is replaced by a vinyl resin. The resultant cores are found to have a volume-average particle size of 33.2 nm.

### Preparation of Core Particles 3

Core particles 3 are obtained as with Cores 1 except that the phenol resin is replaced by a silicone resin. The resultant cores are found to have a volume-average particle size of 33.8 nm.

The silicone resin has, as the main chain, siloxane bonds “Si—O—Si”, has, as side chains, organic groups, and has a three-dimensional network structure. The silicone resin has a structure represented by Formula (1-1) or Formula (1-2) below. In Formula (1-1) and Formula (1-2), n₁₁, n₂₁, and n₂₂ each independently represent the repeating number (desired number) of the constituent repeating unit.

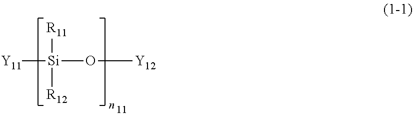

In Formula (1-1), R₁₁ represents an organic group (more specifically, a methyl group or a phenyl group). R₁₂ represents a hydrogen atom or an organic group (more specifically, a methyl group or a phenyl group). R₁₁ and R₁₂ may be the same or different. Y₁₁ represents a first terminal moiety, and Y₁₂ represents a second terminal moiety. As the first terminal moiety, for example, an organosiloxy group (more specifically, a trimethylsiloxy group) is attached. As the second terminal moiety, for example, an organosilyl group (more specifically, a trimethylsilyl group) is attached.

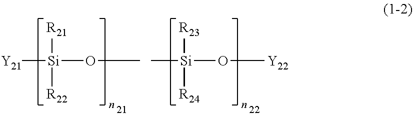

In Formula (1-2), P₂₁, R₂₂, and R₂₃ each independently represent an organic group (more specifically, a methyl group or a phenyl group). R₂₄ each independently represents a hydrogen atom or an organic group (more specifically, a methyl group or a phenyl group). Y₂₁ represents a first terminal moiety, and Y₂₂ represents a second terminal moiety. As the first terminal moiety, for example, an organosiloxy group (more specifically, a trimethylsiloxy group) is attached. As the second terminal moiety, for example, an organosilyl group (more specifically, a trimethylsilyl group) is attached.

### Preparation of Silica Particles Internally Added to Resin Cover Layers

### Silica Particles (1) (Inorganic Particles 1)

Commercially available hydrophilic silica particles (fumed silica particles, no surface treatment, volume-average particle size: 40 nm) are prepared as Silica particles (1).

### Silica Particles (2) (Inorganic Particles 2)

Into a glass reaction vessel equipped with a stirrer, a dropping nozzle, and a thermometer, 890 parts of methanol and 210 parts of 9.8% ammonia water are placed and mixed, to obtain an alkali catalyst solution. The alkali catalyst solution is adjusted to 45° C. and subsequently, under stirring, 550 parts of tetramethoxysilane and 140 parts of 7.6% ammonia water are simultaneously added dropwise over 450 minutes, to obtain Silica-particle dispersion liquid (A) For the silica particles in Silica-particle dispersion liquid (A), the volume-average particle size is found to be 4 nm, and the volume-average particle size distribution index ((D84v/D16v)^{1/2}, the square root of a ratio of, in the volume-based particle size distribution, a particle size D84v corresponding to a cumulative value of 84% in a curve drawn from the smaller to larger particle sizes to a particle size D16v corresponding to a cumulative value of 16%) is found to be 1.2.

Silica-particle dispersion liquid (A) (300 parts) is placed into an autoclave equipped with a stirrer, and the stirrer is rotated at 100 rpm. Under the rotation of the stirrer, liquid carbon dioxide is injected, from a carbon dioxide cylinder, via a pump, into the autoclave; while the internal temperature of the autoclave is increased using a heater, the internal pressure is increased using a pump to bring the internal environment of the autoclave to a supercritical state at 150° C. and at 15 MPa. While the pressure valve is adjusted to keep the internal pressure of the autoclave at 15 MPa, supercritical carbon dioxide is passed, to remove methanol and water from Silica-particle dispersion liquid (A). At the time when the amount of carbon dioxide supplied into the autoclave reaches 900 parts, supply of carbon dioxide is stopped and powder of silica particles is obtained.

While the heater and the pump are used to keep the internal environment of the autoclave at 150° C. and at 15 MPa to maintain the supercritical state of carbon dioxide, under rotation of the stirrer of the autoclave, 50 parts of hexamethyldisilazane relative to 100 parts of silica particles is injected, using an entrainer pump, into the autoclave, and the internal temperature of the autoclave is increased to 180° C. to cause a reaction for 20 minutes. Subsequently, supercritical carbon dioxide is passed again through the autoclave, to remove an excess of hexamethyldisilazane. Subsequently, stirring is stopped, and the pressure valve is opened until the internal pressure of the autoclave reaches the atmospheric pressure and the internal temperature decreases to room temperature (25° C.). In this way, Silica particles (2) having surfaces having been treated with hexamethyldisilazane are obtained. Silica particles (2) are found to have a volume-average particle size of 4 nm.

### Silica Particles (3) (Inorganic Particles 3)

As in the preparation of Silica particles (2), Silica particles (3) having surfaces having been treated with hexamethyldisilazane are obtained except that, during preparation of Silica-particle dispersion liquid (A), the amounts of tetramethoxysilane and 7.6% ammonia water added dropwise are increased and the volume-average particle size of silica particles in the silica particle dispersion liquid is changed to 6 nm. Silica particles (3) are found to have a volume-average particle size of 7 nm.

### Silica Particles (4) (Inorganic Particles 4)

Commercially available hydrophobic silica particles (fumed silica particles having surfaces having been treated with hexamethyldisilazane, volume-average particle size: 12 nm) are prepared as Silica particles (4).

### Silica Particles (5) (Inorganic Particles 5)

Commercially available hydrophilic silica particles (fumed silica particles, no surface treatment, volume-average particle size: 62 nm) are prepared as Silica particles (5).

### Silica Particles (6) (Inorganic Particles 6)

Commercially available hydrophobic silica particles (fumed silica particles having surfaces having been treated with hexamethyldisilazane, volume-average particle size: 88 nm) are prepared as Silica particles (6).

### Silica Particles (7) (Inorganic Particles 7)

Commercially available hydrophobic silica particles (fumed silica particles having surfaces having been treated with hexamethyldisilazane, volume-average particle size: 93 nm) are prepared as Silica particles (7).

### Preparation of Coating Agent for Forming Carrier Resin Cover Layers

### Coating Agent (1)

Resin (1) (perfluoropropylethyl methacrylate-methyl methacrylate copolymer (mass-based polymerization ratio=30:70), weight-average molecular weight Mw=19,000): 12.12 parts

Resin (2) (polycyclohexyl methacrylate, weight-average molecular weight: 350,000): 8.08 parts

Carbon black (manufactured by Cabot Corporation, VXC72): 0.8 parts

Inorganic particles (1): commercially available hydrophilic silica particles (fumed silica particles, no surface treatment, volume-average particle size: 40 nm): 9 parts

Toluene: 250 parts

Isopropyl alcohol: 50 parts

The above-described materials and glass beads (diameter: 1 mm, the same amount as in toluene) are placed into a sand mill, and stirred at 190 rpm for 30 minutes, to obtain Coating agent (1).

### Examples 1 to 21 and Comparative Examples 1 to 5

### Preparation of Resin-Covered Carrier

### Preparation of Carrier 1

Ferrite particles (1) (1,000 parts) and a half amount of Coating agent (1) are placed into a kneader, and mixed at room temperature (25° C.) for 20 minutes. Subsequently, the content is heated to 70° C. under a reduced pressure, to thereby be dried.

The dry content is cooled to room temperature (25° C.); the remaining half amount of Coating agent (1) is additionally added, and the content is mixed at room temperature (25° C.) for 20 minutes. Subsequently, the content is heated to 70° C. under a reduced pressure, to thereby be dried.

Subsequently, the dry content is taken out of the kneader, and sifted through a mesh having openings of 75 μm to remove coarse particles, to obtain Carrier (1).

### Preparation of Carriers 2 to 26

Carriers 2 to 26 are obtained as in the preparation of Carrier 1 except that, as described in Tables 1-1 and 1-2, the type of cores, the type or amounts of resin cover layers, the time for the mixing step, and the time for drying under a reduced pressure are changed.

### Preparation of Developers

Any one of Carriers 1 to 26 and Toner 1 are placed into a V blender in a mixing ratio of carrier:toner=100:10 (mass ratio) and stirred for 20 minutes. In this way, Developers 1 to 26 are obtained.

### Measurement of Average Particle Size of Inorganic Particles in Resin Cover Layers

Such a carrier is embedded in an epoxy resin and a microtome is used for cutting to form a carrier section. The carrier section is photographed using a scanning electron microscope (manufactured by Hitachi, Ltd., S-4100); the resultant SEM image is imported into an image processing analyzer (manufactured by NIRECO CORPORATION, LUZEX AP) and subjected to image analysis. In the resin cover layers, 100 silica particles (primary particles) are randomly selected, and the equivalent circular diameters (nm) of the particles are determined and arithmetically averaged to determine the average particle size (nm) of the inorganic particles.

### Measurement of Inorganic Particle Content in Resin Cover Layers

The inorganic particle content in the resin cover layers is measured in the following manner. In the developer, 2 g of the carrier is separated from the toner and placed into a 20 mL glass vial, and the mass is measured. Subsequently, to the glass vial, 15 mL of methyl ethyl ketone is placed, and stirring is performed using a wave rotor for 10 minutes to dissolve the resin cover layers using the solvent. A magnet is used to remove the solvent, and 10 mL of methyl ethyl ketone is further used to wash the carrier cores (core particles) 3 times. The washed carrier cores are dried and then accurately weighed; the difference of the resultant mass from 2 g of the carrier is determined as the mass of the resin cover layers of the carrier. The removed solvent is dried and the resultant residue corresponds to the mass of the inorganic particles. From the mass of the resin cover layers and the mass of the inorganic particles, the inorganic particle content (mass %) in the resin cover layers in the carrier is calculated.

### Measurement of Average Thickness of Resin Cover Layers

The above-described SEM image is imported into an image processing analyzer (manufactured by NIRECO CORPORATION, LUZEX AP) and subjected to image analysis. The thicknesses (μm) of the resin cover layer at randomly selected 10 positions of a particle of the carrier are measured; this measurement is further performed for 100 particles of the carrier; all the measured thicknesses are arithmetically averaged to determine the average thickness (μm) of the resin cover layers.

### Measurement of Surface Coverage of Resin Cover Layers and Surface Exposure Ratio of Inorganic Particles

Such a carrier is used as a sample and analyzed by X-ray photoelectron spectroscopy (XPS) under the following conditions; from the intensities of the peaks of elements, the iron-element concentration (surface exposure ratio of core particles) in the surfaces of the carrier is measured; in addition, from, for example, the concentration of the silicon element contained in the inorganic particles, the surface exposure ratio (atomic %) of the inorganic particles is determined.

XPS apparatus: manufactured by ULVAC-PHI, Inc., VersaProbe II

Etching gun: argon gun

Acceleration voltage: 5 kV

Emission current: 20 mA

Sputtering region: 2 mm×2 mm

Sputtering rate: 3 nm/min (in terms of SiO₂)

The iron-element concentration in the surfaces of the carrier (surface exposure concentration of core particles) is converted into area; this area is subtracted from the measured area of the carrier, to calculate the area of the resin cover layers; furthermore, the surface coverage of the resin cover layers is calculated.

Sampling of Carrier and Core Particles from Developer

From such a developer, a 16 μm mesh is used to separate the carrier. For the separated carrier, for example, toluene is used to dissolve the coating layers to take out the core particles. The solvent is appropriately changed in accordance with the coating resin. During the dissolution, depending on the solvent, heating or application of ultrasonic waves is performed, for example.

### Volume-Average Particle Size of Core Particles

The volume-average particle size of core particles is measured using a laser diffraction particle size distribution analyzer LA-700 (manufactured by HORIBA, Ltd.).

### Evaluation

The following image forming apparatus is used. The initial evaluation is performed using the 10th printing paper sheet. The later evaluation is performed using a printing paper sheet after printing on 10,000 printing paper sheets.

Image forming apparatus: DocuCentre VII C7773 (manufactured by Fuji Xerox Co., Ltd., printing speed: 70 ppm (page per minute))

### Suppression of Bead-Carry-Out (BCO) of Carrier to Image Holding Member

In the above-described system and environment, 10,000 A4-sized plain paper sheets (manufactured by Fuji Xerox Co., Ltd., C2 paper) are continuously passed for run at a low coverage (area coverage: 0.5%). Subsequently, for evaluation in terms of BCO, an A3-sized whole-surface halftone chart is printed; the number of carrier particles on the image is counted, and evaluated into one of the following evaluation grades.

G1: The number of carrier particles is 0.

G2: The number of carrier particles is 1 or more and 3 or less.

G3: The number of carrier particles is 4 or more and 6 or less.

G4: The number of carrier particles is 7 or more, which is problematic in the actual usage.

### Charging Rapidness

After the BCO evaluation is performed, the system is left overnight. After 100 white paper sheets are passed, a chart having an area coverage of 40% is printed on 10,000 sheets and the image, in particular, image fog is examined and evaluated into one of the following evaluation grades.

G1: The image has no problem at all.

G2: The image has small fog that is not instantly detected visually, but is detectable using a loupe.

G3: The image has misregistration causing slight fog (visually detectable, but at a low level).

G4: The image has misregistration causing fog that is problematic in the actual usage.

TABLE 1-1

| | | Core particles | | | Resin cover layers | | | | |
|---|---|---|---|---|---|---|---|---|---|
| | | | | Volume-average | | Amount of | Amount of | Mw of | Surface |
| | Carrier | | Type of | particle | | PFEM/MM added | CHM added | CHM | coverage |
| | Type | Type | resin | size (μm) | Type of resin | (parts by mass) | (parts by mass) | (×10⁴) | (%) |
| Example 1 | 1 | 1 | Phenol | 33.0 | PFEM/MM + CHM | 12.12 | 8.08 | 15 | 99.2 |
| Example 2 | 2 | 1 | Phenol | 33.0 | PFEM/MM + CHM | 5.82 | 3.88 | 15 | 96.2 |
| Example 3 | 3 | 1 | Phenol | 33.0 | PFEM/MM + CHM | 8.52 | 5.68 | 15 | 98.8 |
| Example 4 | 4 | 1 | Phenol | 33.0 | PFEM/MM + CHM | 15.72 | 10.48 | 15 | 98.6 |
| Example 5 | 5 | 1 | Phenol | 33.0 | PFEM/MM + CHM | 15.72 | 10.48 | 15 | 98.8 |
| Example 6 | 6 | 1 | Phenol | 33.0 | PFEM/MM + CHM | 8.52 | 5.68 | 15 | 98.6 |
| Example 7 | 7 | 2 | Vinyl | 33.2 | PFEM/MM + CHM | 12.12 | 8.08 | 15 | 99.0 |
| Example 8 | 8 | 3 | Silicone | 33.8 | PFEM/MM + CHM | 12.12 | 8.08 | 15 | 99.0 |
| Example 9 | 9 | 1 | Phenol | 33.0 | PFEM/MM + CHM | 4.04 | 16.16 | 28 | 98.6 |
| Example 10 | 10 | 1 | Phenol | 33.0 | CHM | 0 | 20.2 | 35 | 98.8 |
| Example 11 | 11 | 1 | Phenol | 33.0 | PFEM/MM + CHM | 6.06 | 14.14 | 25 | 98.1 |
| Example 12 | 12 | 1 | Phenol | 33.0 | PFEM/MM + CHM | 12.12 | 8.08 | 15 | 99.6 |
| Example 13 | 13 | 1 | Phenol | 33.0 | PFEM/MM + CHM | 12.12 | 8.08 | 15 | 99.5 |
| Example 14 | 14 | 1 | Phenol | 33.0 | PFEM/MM + CHM | 12.12 | 8.08 | 15 | 99.4 |
| Example 15 | 15 | 1 | Phenol | 33.0 | PFEM/MM + CHM | 12.12 | 8.08 | 15 | 99.0 |
| Example 16 | 16 | 1 | Phenol | 33.0 | PFEM/MM + CHM | 12.12 | 8.08 | 15 | 98.8 |
| Example 17 | 17 | 1 | Phenol | 33.0 | PFEM/MM + CHM | 12.12 | 8.08 | 15 | 98.6 |
| Example 18 | 18 | 1 | Phenol | 33.0 | PFEM/MM + CHM | 5.82 | 3.88 | 15 | 96.8 |
| Example 19 | 19 | 1 | Phenol | 33.0 | PFEM/MM + CHM | 6.66 | 4.44 | 15 | 97.0 |
| Example 20 | 20 | 1 | Phenol | 33.0 | PFEM/MM + CHM | 17.16 | 11.44 | 15 | 99.8 |
| Example 21 | 21 | 1 | Phenol | 33.0 | PFEM/MM + CHM | 18.42 | 12.28 | 15 | 99.9 |
| Comparative | 22 | 1 | Phenol | 33.0 | PFEM/MM + CHM | 4.14 | 2.76 | 15 | 95.7 |
| Example 1 | | | | | | | | | |
| Comparative | 23 | 1 | Phenol | 33.0 | PFEM/MM + CHM | 8.16 | 5.44 | 15 | 99.0 |
| Example 2 | | | | | | | | | |
| Comparative | 24 | 1 | Phenol | 33.0 | PFEM/MM + CHM | 15.9 | 10.6 | 15 | 98.0 |
| Example 3 | | | | | | | | | |
| Comparative | 25 | 1 | Phenol | 33.0 | PFEM/MM + CHM | 8.52 | 5.68 | 15 | 99.0 |
| Example 4 | | | | | | | | | |
| Comparative | 26 | 1 | Phenol | 33.0 | PFEM/MM + CHM | 15.72 | 10.48 | 15 | 99.0 |
| Example 5 | | | | | | | | | |

TABLE 1-2

| | Resin cover layers | | | | | Conditions of preparation | |
|---|---|---|---|---|---|---|---|
| | | Amount of | Content of | Surface | | of carrier | |
| | Type of | inorganic particles | inorganic | exposure ratio of | Average | Time for mixing | Time for drying |
| | inorganic | added (parts | particles | inorganic particles | thickness | after additional | under reduced |
| | particles | by mass) | (mass %) | (atomic %) | (um) | addition (min) | pressure (min) |
| Example 1 | 1 | 9 | 30 | 9.7 | 1.0 | 20 | 20 |
| Exampie 2 | 1 | 4.5 | 30 | 8.7 | 0.5 | 20 | 10 |
| Example 3 | 1 | 15 | 50 | 14.0 | 0.9 | 25 | 25 |
| Exampie 4 | 1 | 3 | 10 | 6.4 | 1.1 | 15 | 10 |
| Exampie 5 | 1 | 15 | 10 | 6.1 | 1.1 | 20 | 20 |
| Exampie 6 | 1 | 3 | 50 | 14.9 | 0.9 | 20 | 20 |
| Exampie 7 | 1 | 9 | 30 | 9.7 | 1.0 | 20 | 20 |
| Exampie 8 | 1 | 9 | 30 | 9.6 | 1.0 | 20 | 20 |
| Exampie 9 | 1 | 9 | 30 | 10.1 | 1.0 | 20 | 20 |
| Exampie 10 | 1 | 9 | 30 | 10.5 | 1.0 | 20 | 20 |
| Exampie 11 | 1 | 9 | 30 | 9.8 | 1.0 | 20 | 20 |
| Example 12 | 2 | 9 | 30 | 11 5 | 1.0 | 20 | 20 |
| Example 13 | 3 | 9 | 30 | 11 3 | 1.0 | 20 | 20 |
| Example 14 | 4 | 9 | 30 | 10.4 | 1.0 | 20 | 20 |
| Example 15 | 5 | 9 | 30 | 9.5 | 1.0 | 20 | 20 |
| Example 16 | 6 | 9 | 30 | 9.3 | 1.0 | 20 | 20 |
| Example 17 | 7 | 9 | 30 | 9.0 | 1.0 | 20 | 20 |
| Example 18 | 1 | 4S | 30 | 8.8 | 0.5 | 18 | 8 |
| Example 19 | 1 | 5.1 | 30 | 8.9 | 0.6 | 18 | 8 |
| Example 20 | 1 | 12.6 | 30 | 10.7 | 1.4 | 20 | 20 |
| Example 21 | 1 | 13.5 | 30 | 10.8 | 1.5 | 20 | 20 |
| Comparative | 1 | 6.4 | 45 | 6.0 | 0.4 | 20 | 20 |
| Example 1 | | | | | | | |
| Comparative | 1 | 15.6 | 52 | 14.8 | 1.2 | 20 | 20 |
| Example 2 | | | | | | | |
| Comparative | 1 | 2.7 | 9 | 6.4 | 0.9 | 20 | 20 |
| Example 3 | | | | | | | |
| Comparative | 1 | 3 | 50 | 15.2 | 0.9 | 15 | 10 |
| Example 4 | | | | | | | |
| Comparative | 1 | 15 | 10 | 5.8 | 1.1 | 25 | 25 |
| Example 5 | | | | | | | |

TABLE 1-3

| | | | Suppression of | | | |
|---|---|---|---|---|---|---|
| | | | bead-carry-out of | | | |
| | Volume-average | Type | carrier to image | | Charging | |
| | particle size of | of | holding member | | rapidness | |
| | carrier (μm) | toner | Initial | Later | Initial | Later |
| Example 1 | 34.2 | 1 | G1 | G1 | G1 | G1 |
| Example 2 | 33.6 | 1 | G2 | G3 | G1 | G1 |
| Example 3 | 34.4 | 1 | G1 | G1 | G2 | G2 |
| Example 4 | 34.3 | 1 | G1 | G3 | G1 | G3 |
| Example 5 | 34.2 | 1 | G1 | G1 | G2 | G2 |
| Example 6 | 34.3 | 1 | G1 | G1 | G3 | G3 |
| Example 7 | 34.2 | 1 | G1 | G2 | G1 | G2 |
| Example 8 | 34.4 | 1 | G1 | G2 | G1 | G2 |
| Example 9 | 34.5 | 1 | G1 | G2 | G2 | G3 |
| Example 10 | 34.3 | 1 | G1 | G2 | G2 | G3 |
| Example 11 | 34.3 | 1 | G1 | G1 | G1 | G2 |
| Example 12 | 34.1 | 1 | G1 | G1 | G2 | G3 |
| Example 13 | 34.0 | 1 | G1 | G2 | G2 | G2 |
| Example 14 | 34.1 | 1 | G1 | G2 | G1 | G1 |
| Example 15 | 34.2 | 1 | G1 | G2 | G1 | G1 |
| Example 16 | 34.3 | 1 | G2 | G2 | G1 | G1 |
| Example 17 | 34.4 | 1 | G2 | G3 | G1 | G1 |
| Example 18 | 33.5 | 1 | G2 | G3 | G1 | G1 |
| Example 19 | 33.6 | 1 | G2 | G2 | G1 | G1 |
| Example 20 | 34.4 | 1 | G1 | G1 | G1 | G2 |
| Example 21 | 34.2 | 1 | G1 | G1 | G2 | G3 |
| Comparative | 34.0 | 1 | G3 | G4 | G1 | G1 |
| Example 1 | | | | | | |
| Comparative | 34.6 | 1 | G1 | G1 | G4 | G4 |
| Example 2 | | | | | | |
| Comparative | 34.6 | 1 | G1 | G4 | G1 | G4 |
| Example 3 | | | | | | |
| Comparative | 34.2 | 1 | G1 | G1 | G4 | G4 |
| Example 4 | | | | | | |
| Comparative | 34.3 | 1 | G1 | G1 | G4 | G4 |
| Example 5 | | | | | | |

Note that the abbreviations in Table 1-1 are as follows.

PFEM/MM: perfluoropropylethyl methacrylate/methyl methacrylate copolymer (mass-based polymerization ratio=30:70, weight-average molecular weight Mw=19,000)

CHM: polycyclohexyl methacrylate (having a weight-average molecular weight Mw described in Table 1-1)

The above-described results have demonstrated that, compared with Comparative Examples, Examples are excellent in later suppression of bead-carry-out of the carrier to the image holding member and later charging rapidness.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An electrostatic image developing carrier comprising:
core particles provided by dispersing a magnetic powder in a resin; and
resin cover layers covering the core particles,
wherein the resin cover layers have a surface coverage of 96 area % or more,
the resin cover layers include 10 mass % or more and 50 mass % or less of inorganic particles relative to a total mass of the resin cover layers, and
the inorganic particles in surfaces of the carrier have a surface exposure ratio of 6 atomic % or more and 15 atomic % or less determined by X-ray photoelectron spectroscopy.

2. The electrostatic image developing carrier according to claim 1, wherein the resin in the core particles includes phenol resin.

3. The electrostatic image developing carrier according to claim 1, wherein the inorganic particles include inorganic oxide particles.

4. The electrostatic image developing carrier according to claim 2, wherein the inorganic particles include inorganic oxide particles.

5. The electrostatic image developing carrier according to claim 1, wherein the inorganic particles include silica particles.

6. The electrostatic image developing carrier according to claim 2, wherein the inorganic particles include silica particles.

7. The electrostatic image developing carrier according to claim 3, wherein the inorganic particles include silica particles.

8. The electrostatic image developing carrier according to claim 4, wherein the inorganic particles include silica particles.

9. The electrostatic image developing carrier according to claim 1, wherein the resin cover layers have an average thickness of 0.6 μm or more and 1.4 μm or less.

10. The electrostatic image developing carrier according to claim 2, wherein the resin cover layers have an average thickness of 0.6 μm or more and 1.4 μm or less.

11. The electrostatic image developing carrier according to claim 3, wherein the resin cover layers have an average thickness of 0.6 μm or more and 1.4 μm or less.

12. The electrostatic image developing carrier according to claim 4, wherein the resin cover layers have an average thickness of 0.6 μm or more and 1.4 μm or less.

13. The electrostatic image developing carrier according to claim 5, wherein the resin cover layers have an average thickness of 0.6 μm or more and 1.4 μm or less.

14. The electrostatic image developing carrier according to claim 1, wherein the resin cover layers include acrylic resin.

15. The electrostatic image developing carrier according to claim 1, wherein the resin cover layers include a resin having a weight-average molecular weight of less than 300,000.

16. The electrostatic image developing carrier according to claim 15, wherein the resin included in the resin cover layers has a weight-average molecular weight of less than 250,000.

17. An electrostatic image developer comprising:
an electrostatic image developing toner; and
the electrostatic image developing carrier according to claim 1.

18. A process cartridge comprising:
a developing section housing the electrostatic image developer according to claim 17 and configured to develop, using the electrostatic image developer, an electrostatic image formed on a surface of an image holding member, to form a toner image,
wherein the process cartridge is attachable to and detachable from an image forming apparatus.

19. An image forming apparatus comprising:
an image holding member;
a charging section configured to charge a surface of the image holding member;
an electrostatic image forming section configured to form, on the charged surface of the image holding member, an electrostatic image;
a developing section housing the electrostatic image developer according to claim 17 and configured to develop, using the electrostatic image developer, the electrostatic image formed on the surface of the image holding member, to form a toner image;
a transfer section configured to transfer the toner image formed on the surface of the image holding member onto a surface of a recording medium; and
a fixing section configured to fix the transferred toner image on the surface of the recording medium.

20. An image forming method comprising:
charging a surface of an image holding member;
forming an electrostatic image on the charged surface of the image holding member;
developing, using the electrostatic image developer according to claim 17, the electrostatic image formed on the surface of the image holding member, to form a toner image;
transferring the toner image formed on the surface of the image holding member onto a surface of a recording medium; and
fixing the transferred toner image on the surface of the recording medium.
